(19) United States
(12) Patent Application Publication
(10) Pub. No.: US 2025/0005145 A1
(43) Pub. Date: Jan. 2, 2025

(54) DETECTING INSIDER USER BEHAVIOR THREATS BY COMPARING A CURRENT (LATEST) USER ACTIVITY TO USER ACTIVITIES OF OTHERS

(71) Applicant: Proofpoint, Inc., Sunnyvale, CA (US)

(72) Inventors: Ram Kulathumani, Sunnyvale, CA (US); Khurram Ghafoor, Lexington, MA (US); Alexander Kremer, Lexington, MA (US); Christopher Covney, Sunnyvale, CA (US)

(21) Appl. No.: 18/703,348

(22) PCT Filed: Oct. 26, 2022
(86) PCT No.: PCT/US22/78681

§ 371 Date: Apr. 21, 2024

Related U.S. Application Data
(60) Provisional application No. 63/272,213, filed on Oct. 27, 2021.

(51) Int. Cl. G06F 21/55

(52) U.S. Cl. CPC G06F 21/552

(57) ABSTRACT

A computer method detect internal user behavior threats by recording user activity data at endpoints on a computer network associated with a tenant, generating a sampled activity matrix for each user, grouping users from the tenant into clusters based on similarity, assigning a user activity weight to each activity-set, creating a ranked list of the user activity-sets for all users within the tenant, computing a user behavior vector for each respective one of the users in the tenant, and comparing the user behavior vector for a particular one of the users in the tenant to other users in the tenant to determine whether the user behavior vector indicates that the user behavior deviates beyond a threshold amount from the other users in the tenant, and, if so, creating an internal user behavior threat notification that may, for example, prompt a real world response.

### CROSS-REFERENCE TO RELATED APPLICATION(S)

This application claims the benefit of priority to U.S. Provisional Patent Application No. 63/272,213, entitled SECURITY SYSTEMS AND TECHNIQUES, which was filed on Oct. 27, 2021. This application also is related to another application being filed by the applicant concurrently and entitled, DETECTING INSIDER USER BEHAVIOR THREATS BY COMPARING A USER'S BEHAVIOR TO THE USER'S PRIOR BEHAVIOR (Attorney Docket No. 46353-8114). The disclosures of these applications are incorporated by reference herein in their entirety.

### FIELD OF THE INVENTION

This disclosure relates to detecting insider user behavior threats and, more specifically, relates to computer systems and methods for detecting insider user behavior threats with a computer-based security system using computer-implemented processes disclosed herein.

### BACKGROUND

Various computer-based systems exist that monitor user behavior at endpoint devices (e.g., computers) on a network. One example of this kind of system is an insider threat management system, such as the ObserveIT ITM (insider threat management) system, available from Proofpoint, Inc., the applicant of this patent application. In general terms, an insider threat occurs when someone with authorized access to critical information or systems misuses that access—either purposefully or accidentally—resulting in data loss, legal liability, financial consequences, reputational damage, and/or other forms of harm to the person's employer. Insider threats are on the rise and incidents thereof can be extremely costly, both in terms of reputation and finances, to the employer. The cost and complexity of operating an effective ITM system (or other system where potentially large amounts of collected may be transmitted a network to some centralized storage or processing facility) can be high due, for example, to the infrastructure and functional demands associated with transmitting, storing, and processing large amounts of data.

### SUMMARY OF THE INVENTION

In one aspect, a computer-implemented method is disclosed to detect internal user behavior threats (e.g., in a multitenant software as a service (SaaS) security system) by comparing behavior of a user in a particular one of the tenants to behavior of other users in the tenant. The method includes recording user activity data representing activities by a plurality of users within the tenant at endpoints on a computer network associated with the tenant, generating a sampled activity matrix for each respective one of the plurality of users based on the recorded user activity data, grouping users from the particular tenant into clusters based on similarity between ranked lists of activity-sets for each user (where the ranked list of activity-sets for each user is derived from the recorded user activity data for that user), assigning a user activity weight to each respective one of the activity-sets in the sampled activity matrices, creating a ranked list of the user activity-sets for all the users within the tenant in each respective one of a plurality of time windows (e.g., across all the discrete periods of time and/or based on a variance computation), computing a user behavior vector for each respective one of the users in the tenant; comparing the user behavior vector for a particular one of the users in the tenant to other users in the tenant to determine whether the user behavior vector indicates that the user behavior deviates beyond a threshold amount from the other users in the tenant; and creating an internal user behavior threat notification in response to a determination that the user behavior deviates beyond the threshold amount from the other users in the tenant.

In a typical implementation, the notification (of the user behavior threat) may cause a human recipient to take one or more real-world steps to address, investigate, and/or try to remedy any ill effects or future threats suggested by the behavior of the user that led to the notification.

Also disclosed is a computer system that is configured to detect internal user behavior threats in a multitenant software as a service (SaaS) security system by comparing behavior of a user in a particular one of the tenants to behavior of other users in the tenant. The computer system has a computer processor; and computer-based memory operatively coupled to the computer processor. The computer-based memory stores computer-readable instructions that, when executed by the computer processor, cause the computer-based system to perform the steps outlined above (and otherwise disclosed herein) to facilitate threat detection, notification, and subsequent real-world action.

Additionally, a non-transitory computer readable medium is disclosed that has stored thereon computer-readable instructions that, when executed by a computer-based processor, cause the computer-based processor to detect internal user behavior threats in a multitenant software as a service (SaaS) security system by comparing behavior of a user in a particular one of the tenants to behavior of other users in the tenant. The computer system, in a typical implementation, does this by performing the steps outlined above (and otherwise disclosed herein) to facilitate threat detection, notification, and subsequent real-world action.

In some implementations, one or more of the following advantages are present.

For example, in various implementations, the systems and techniques disclosed herein provide for an insider threat management system that is fast, dependable, highly relevant, and actionable. Typical approaches disclosed herein look not only at individual user activities at an endpoint but place those activities into a broader context to facilitate better analysis and outcomes by the system. More specifically, in a typical implementation, the system and techniques disclosed herein consider the significance of individual user activities in the overall context of user activities by others on the network.

The systems and techniques disclosed herein can be deployed easily in a multitenant software-as-a-service (SaaS) environment. This sort of deployment can be done in a highly effective, efficient, and scalable manner.

Other features and advantages will be apparent from the description and drawings, and from the claims.

### BRIEF DESCRIPTION OF THE DRAWINGS

FIG. 1 is a schematic representation of a computer network hosting a computer-based security system to monitor insider behavior at endpoint devices on the network and to detect any insider user behavior threats presented by the monitored insider behavior.

FIGS. 2-5 are each schematic representations showing a partial implementation of a cloud data architecture that includes certain components of the security monitoring system deployed on the network of FIG. 1.

FIG. 6 is a schematic representation showing a portion of an implementation of the security monitoring system of FIGS. 2-5 deployed across a portion of the computer network of FIG. 1.

FIG. 7 is a schematic representation of an exemplary implementation of a computer device (e.g., a network endpoint) configured to perform at least some of the computer implemented insider threat management (ITM) functionalities disclosed herein, and/or to facilitate (in conjunction with other computer devices on the network) other computer-implemented ITM functionalities disclosed herein.

FIGS. 8-10 are each schematic representations showing an alternative partial implementation of a cloud data architecture that includes certain components of the security monitoring system deployed on the network of FIG. 1.

Like reference characters refer to like elements.

### DETAILED DESCRIPTION

This document uses a variety of terminology to describe the inventive concepts set forth herein. Unless otherwise indicated, the following terminology, and variations thereof, should be understood as having meanings that are consistent with what follows.

The phrase “insider threat,” or “internal threat” refers to a threat to an organization from negligent or malicious “insiders” (e.g., employees, third-party vendors, business partners, etc.) who have access to confidential information about the organization's security practices and/or data and/or computer systems. A “threat” may involve or relate to, for example, theft of confidential or commercially valuable information, intellectual property, fraud, sabotage of computer systems, etc. Insider threats can happen when someone close to an organization with authorized access misuses that access to negatively impact the organization's critical information or systems.

The phrase “insider user behavior threat” or “internal user behavior threat” refers to a threat posed to a tenant (organization) by an insider's activities at an endpoint (computing device) on a network.

“Insider threat management” or “ITM” refers to the practice of combining tools, policies, and processes to detect, mitigate, and respond to insider threats, e.g., security incidents caused by an organization's insiders.

“Software-as-a-Service” or “SaaS” refers to a software or a software licensing model in which access to the software is provided to users typically on a subscription basis, with the software stored on external servers rather than on servers owned or under direct control of the software users. “SaaS” is sometimes referred to as “on-demand software.”

In “multitenant” software architecture, a single instance of a software application (and typically its underlying database and hardware) serves multiple tenants (or user accounts) connected to a computer network (e.g., the Internet). A “tenant” can be an individual user (or user account). However, more frequently, a “tenant” is a group of users (or user accounts) that shares common access to and privileges within the application instance. One example of a group of users that would qualify as a single tenant would be members of a particular company or other organization (a “tenant organization”) that share common access to and privileges within a particular computer application. Typically, the users in each tenant are able to access the application instance via a network (e.g., the Internet). Moreover, each tenant's data typically is isolated from, and invisible to, the other tenants sharing the application instance, ensuring data security and privacy for all tenants. In an exemplary multitenant software architecture, a first tenant may be a first company (and include all the people working at that first company), a second tenant may be a second company (and include all the people working at that second company), etc. SaaS is often delivered on a multitenant architecture.

A “user” or an “insider” is a person who is close to an organization (e.g., a tenant organization) and who is authorized to access confidential or sensitive information of the organization (e.g., via an endpoint on the organization's computer network).

The phrase “user activity,” “insider activity,” or the like, refers to a user's interaction at or with an endpoint (e.g., computing device) on a network. Some examples of users' activities include the use of applications, windows opened, system commands executed, checkboxes clicked, text entered/edited, keystrokes, mouse clicks, URLs visited, and other on-screen events. In a multitenant environment, each user typically performs activities at one or more endpoints associated with that tenant to which that user belongs. Every user activity typically generates “activity data” that represents or describes some aspect of the user activity. Moreover, a user activity typically influences the functionality of the endpoint where the user activity happened, as well as potentially other devices connected to the same network as the endpoint.

The phrases “activity data,” “user activity data,” “insider activity data,” or the like, refers to data (that may be stored in computer memory) that represents or describes some aspect of users' activities (e.g., at an endpoint—computing device—on a network). The data may be stored in computer memory, for example, in the form of a “user activity log” or “activity data store” (e.g., an activity blob data store). Some examples of data stored in a user activity log include names of applications run, titles of pages opened, uniform resource locators (URLs) accessed, text (typed, edited, copied/pasted), commands entered, and/or scripts run. The data stored in the user activity log also may include visual records data (e.g., screen-captures and/or videos showing exactly what a user has done on screen at the endpoint device). In a typical implementation, the written record in the user activity log (that includes, for example, user-level data that includes names of applications run, titles of pages opened, URLs accessed, text (typed, edited, copied/pasted), commands entered, and/or scripts run) is paired to the visual record (that includes screen-captures and/or videos showing exactly what a user has done on screen). The pairing associates individual items of data in the written record with corresponding individual items of data in the visual record based on timestamps for each item of data.

An “endpoint” is a physical device that connects to and exchanges information with a computer network and/or other physical devices that are connected to and able to exchange information over the computer network. In a typical implementation, each tenant in a multitenant architecture has multiple endpoints. Examples of endpoints include computer workstations, servers, laptops, tablets, mobile computing devices (e.g., a mobile phones, etc.), and other wired or wireless devices connected to an organization's computer network.

The term “timestamp” refers to a sequence of characters or encoded information that identifies when a certain event happened, and usually represents a date and time of day for the event. Timestamps, however, do not have to be based on some absolute notion of time. Timestamps are usually presented in a consistent format, allowing for easy comparison of two different records and tracking progress over time. The practice of recording timestamps in a consistent manner together and correlated with the timestamped data is called “timestamping.” In a computing environment timestamps and/or associated timestamping data may be recoded and stored in digital format in computer-based memory or storage. In various implementations, every user activity may be individually timestamped.

The term “metadata” refers to data that provides information about other data, but not the actual content (e.g., text, image, etc.) of the other data. In a computing environment metadata may be recorded and stored in a digital format in computer-based memory or storage. Moreover, each piece of metadata may be stored together and correlated with the data that that piece of metadata describes. Some examples of metadata that may be associated with a particular user activity include, for example, geolocation information for the user activity, operating system information (e.g., Windows vs. Mac, etc.) for the user activity, timestamping information for the user activity, name, role, and/or title of the user associated with the activity, access control information for the user associated with the activity, group membership information for the user associated with the activity, name of the file associated with the user activity, location of the file associated with the user activity, sensitivity level for the file associated with the user activity, numbers of certain occurrences, etc. In various implementations, different pieces of user activity data may have various associated metadata.

A “data store” is a computer-implemented repository for depositing and storing data. A data store may be used to persistently store and manage collections of data similar to a database, but also simpler store types such as simple files, emails, user activity information including timestamping information and other associated metadata, etc. Data stores can be implemented in a cloud storage environment as a “cloud data store.”

“Cloud storage” refers to a model of computer data storage in which digital data may be stored in logical pools, for example, said to be on “the cloud”. The physical storage devices, implemented as computer memory, may span multiple servers (sometimes in multiple different locations) and the physical environment of the servers is typically owned and managed by a cloud storage hosting company that is separate from the user of the cloud storage. These cloud storage providers are typically responsible for ensuring availability and accessibility of any data stored in the cloud storage platform, and for keeping the physical environment of the storage servers and other physical equipment secured, protected, and running. People and organizations may buy or lease storage capacity from the cloud storage providers to store user, organization, or application data. Cloud storage services may be accessed, for example, through a co-located cloud computing service, a web service application programming interface (API), or by one or more applications that use the API, such as a cloud desktop storage application, a cloud storage gateway, or a Web-based content management system.

“Cluster analysis” (or “Clustering”) refers to a process that groups a set of data objects in such a way that objects in the same group (called a “cluster”) are more similar (in some sense) to each other than to those in other groups (clusters). Cluster analysis can be achieved by implementing any one or more of various clustering algorithms. Various implementations of clustering algorithms utilize connectivity models (e.g., hierarchical clustering that builds models based on distance connectivity), centroid models (e.g., the k-means algorithm that represents each cluster by a single mean vector), distribution models (where clusters are modeled using statistical distributions, such as multivariate normal distributions used by the expectation-maximization algorithm), density models, subspace models, group models, graph-based models, signed graph models, neural models, etc.

The phrase “cloud access security broker” (or “CASB”) refers to computer-implemented component that that sits between cloud service users and one or more cloud applications and that monitors activity and enforces security policies. A CASB can offer services such as monitoring user activity, warning administrators about potentially hazardous actions, enforcing security policy compliance, and/or automatically preventing malware.

A “dataframe” is a two-dimensional data structure with data organized into rows and columns for example. The data in each row and/or column of a dataframe may represent a particular type of data. For example, a dataframe may be created from user activity data collected for every user at a tenant. In that case, the data frame may have M rows and N columns, where each row represents a sample (e.g., 1-day) and each column represents an activity-set. In some instances, each row and/or column may be labeled in a manner that characterizes the data that appears in that that row and/or column. A dataframe may be stored, for example, in computer memory and accessed, for example, by a computer processor.

An “activity-set” is a collection of data that represents or describes one or more user activities that occurred (e.g., at an endpoint on a network) within a particular period of time. For example, an activity-set may be a collection of 1 or more user activities that occurred (e.g., at an endpoint on a network) and represented by user activity data retrieved from multiple channels (sources) in that network, where the activities (if more than one) occurred within t seconds of each other (where t is a number greater than zero).

A “data store” is a repository for persistently storing and managing collections of data that typically include not just repositories like databases, but also may include simpler store types such as simple files, emails, etc. The phrase “data store,” as used herein, can refer to a broad class of computer-implemented storage systems including, for example, simple files like spreadsheets, file systems, email storage systems, databased (e.g., relational databases, object-oriented databases, noSQL databases), distributed data stores, etc.

A “data lake” is a system or repository of data stored in its natural/raw format, which may include object blobs or files. A data lake is usually a single store of data including raw copies of source system data and transformed data suitable for use in tasks such as reporting, visualization, advanced analytics, and/or machine learning. A data lake can include structured data (e.g., from relational databases (rows and columns), semi-structured data (e.g., CSV, logs, XML, JSON), unstructured data (e.g., emails, documents, pdfs) and/or binary data (e.g., images, audio, video). A data lake can be established “on premises” (e.g., within an organization's data centers) or “in the cloud” (e.g., using cloud services from vendors such as Amazon, Microsoft, or Google). A data lake in the cloud can be referred to as a “cloud data lake.”

“Principal Component Analysis” or (“PCA”), as used herein, refers to a computer-implemented process that summarizes information in a complex data set that is described by multiple variables. More specifically, in a typical implementation, PCA is able to reduce the dimensionality of large data set (e.g., stored in computer-based memory), by transforming (e.g., with a series of computer-processing steps) a large set of variables into a smaller one that still contains most of the information, at least most of the more important information, in the larger set.

A “vector,” as used herein, refers to a quantity (or data stored in computer-based memory that represents a quantity) that has magnitude and direction. A vector may be represented graphically by a directed line segment whose length represents the magnitude and whose orientation in space represents the direction.

The word “administrator” refers to an individual at a tenant organization with responsibility and/or authority to assess and/or respond to insider user behavior threats within the tenant organization.

### Technical Disclosure

Described herein are computer-based systems and methods for detecting insider user behavior threats (“threats”) with a computer-based security system and corresponding computer-implemented processes. The threats can be identified, for example, by comparing a user's behavior to the behavior of other users within the same tenant. In a typical implementation, if a threat has been identified, a notification may be generated and delivered to an individual (or individuals) within the tenant organization who has responsibility and/or authority to address and/or remedy the threat. The notification may be delivered automatically and may be delivered within a security monitoring system application environment, via text, via email, or in some other typically computer-implemented manner. The notification typically identifies the insider involved in the threat and may provide additional information about the insider's behavior (at one or more of the endpoint computing devices) that gave caused the threat to be flagged. Moreover, in a typical implementation, the systems and methods disclosed herein may be deployed as a multitenant software as a service (SaaS) security system to monitor the behavior of insiders at endpoints across multiple different tenant organizations, and reporting on any identified user threat behaviors to one or more corresponding individuals within each respective tenant organization having responsibility and/or authority to take action to address identified user behavior threats identified by the system.

The individual(s) notified of a particular user behavior threat within his or her tenant organization may respond to the notification in any one of a variety of ways that involve real world action. These steps can include, for example, assessing the threat and, if appropriate, remedying the threat. Assessing the threat can include, for example, any one or more of the following—communicating with the insider whose behavior caused the notification, accessing and reviewing computer-captured data and/or other information relevant to the behavior that caused the notification, accessing and reviewing company policies, consulting with information security and/or management personnel within the tenant organization, generating a written threat assessment, etc. If it is determined that the threat was genuine and that the threat actually caused damage to the tenant organization, then, the threat assessment may also include an assessment of any damage done—monetarily, reputation-wise, etc.—to the tenant organization and/or its members/employees.

Remedying the threat, if necessary, may include, for example, any one or more of the following—reprimanding the user, providing the user with training to avoid similar sorts of behavior in the future, changing or reducing the user's role and/or authority within the tenant organization, changing or reducing the user's access to certain information within the organization's network or elsewhere, by changing access control settings for that user in the tenant organization's access control software, by changing or reducing the user's remuneration from the tenant organization, and/or by terminating the user's employment at the tenant organization (e.g., with a termination letter or other comparable communication—email, etc.). Termination may, in some instances, involve or require physically escorting the user off the physical premises and/or removing the user's stuff from his or her workspace. The employee, if terminated, may be prevented from subsequently accessing any of the organization's property, including any real estate (e.g., office space, etc.), computer networks or equipment, data, etc. In some instances, if the user's offending behavior was particularly egregious and/or damaging, the tenant organization may institute a legal action in a court of law against the offending user.

There are many other options and combinations of options that a particular tenant organization might react to an insider threat (e.g., that has been identified using the computer systems and/or computer-implemented processes disclosed herein). These are just a few examples.

The disclosure that follows sets forth different approaches for detecting and flagging internal user behavior threats—by comparing a user's behavior (e.g., a single user activity or single user activity-set) to the behavior of other users (e.g., within the same tenant organization as the user), and by comparing a user's behavior (e.g., a single user activity or single user activity-set) to that user's own prior behavior patterns (e.g., based on prior user activities and user activity-sets by that user).

### System and Method to Detect Internal User Behavior Threats in a Multi-Tenant Software as a Service (SaaS) Security System by Comparing User Behavior to That of Other Users in the Tenant

This section of the disclosure focuses primarily on a computer systems and computer-implemented techniques for detecting internal user behavior threats in a multi-tenant software as a service (SaaS) security system by comparing a user's behavior (e.g., a single user activity or single user activity-set) to the behavior of other users within the user's tenant.

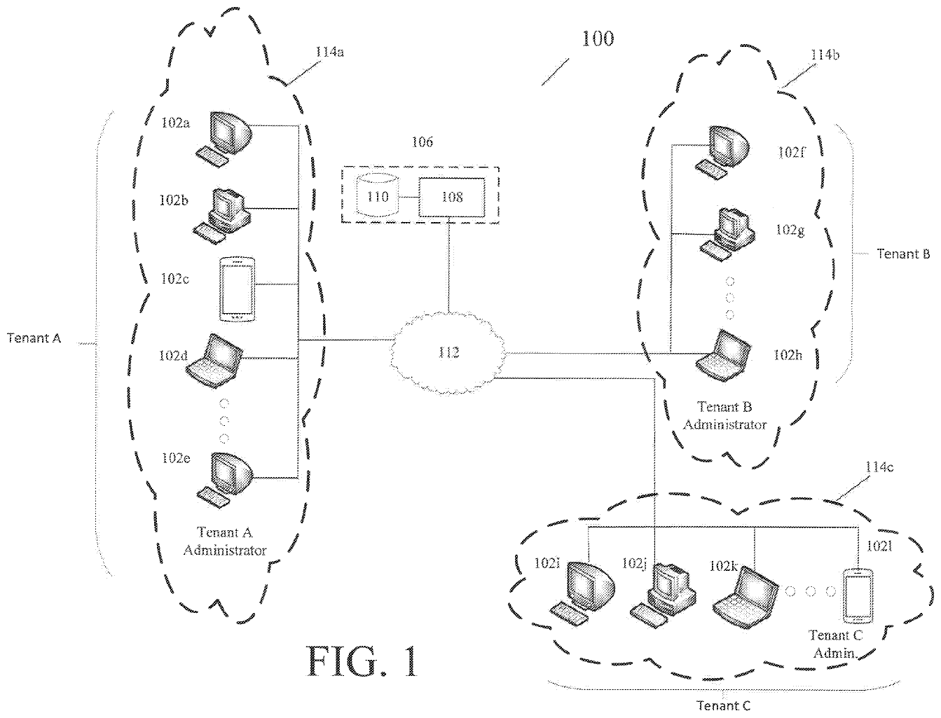

FIG. 1 is a schematic representation of a computer network 100 hosting a computer-based security system to monitor insider behavior at endpoint devices on the network and to detect any insider user behavior threats presented by the monitored insider behavior. The illustrated computer network 100 has a multitenant configuration with three specific tenants: tenant A, tenant B, and tenant C represented in the figure. Each tenant has multiple endpoints including endpoints 102a-102e that belong to tenant A, endpoints 102f-102h that belong to tenant B, and endpoints 102i-102l that belong to tenant C. In addition to the endpoints shown, each tenant typically has its own enterprise level storage and or processing capabilities provided by enterprise servers, for example. In a typical implementation, each endpoint is connected to the other endpoints and computer components within its own tenant organization via its own tenant (enterprise) network 114a, 114b, 114c for example. For example, endpoints 102a-102e are connected to each other and to other computer components dedicated to tenant A via tenant network 114a. Likewise, endpoints 102f-102h are connected to each other and to other computer components dedicated to tenant B via tenant network 114b. Similarly, endpoints 102i-102l are connected to each other and to other computer components dedicated to tenant C via tenant network 114c.

The tenant networks 114a, 114b, 114c are connected to one another via a broader communications network (e.g., the Internet) 112. In various implementations, a firewall operates at each tenant network 114a, 114b, 114c to monitor and/or control incoming traffic (from the Internet 112) and outgoing traffic (to the Internet 112) based on predetermined security rules. In this regard, each firewall establishes a boundary between its internal tenant network 114a, 114b, 114c and the external network (e.g., the Internet 112). The illustrated computer network 100 also has a remote security monitoring platform 106 residing at a server that is remote from the tenant networks 114a, 114b, 114c (i.e., accessible over the Internet 112). This remote server provides server-level computer processing 108 (e.g., with one or more computer processors), and server-level data store(s) 110 (e.g., on computer memory). Each tenant network 114a, 114b, 114c, including the endpoint devices 102a-102l on each tenant network, is connected to and able to communicate with the security monitoring platform 106 via the Internet 112 through their respective firewalls.

The security monitoring platform 106 is part of a security monitoring system that is deployed and able to operate on the computer network 100 and made available to the various tenants A, B, and C based on a multitenant software as a service (“SaaS”) model. In a typical implementation, some components of the securing monitoring system reside on the remote security monitoring platform 106, while other components of the security monitoring system reside at the individual tenant networks 114a, 114b, 114c. At least some of the components of the security monitoring system that reside at the individual tenant networks 114a, 114b, 114c reside at the individual endpoint devices 102a-102l on those tenant networks. In some implementations, other components of the security monitoring system may reside elsewhere on the tenant network (e.g., on an enterprise server for that tenant). The various components of the security monitoring system interact with one another as disclosed herein to perform the various functionalities associated with the security monitoring system.

The illustrated figure represents an individual administrator for each respective one of the tenants. The term “administrator,” as used in this regard, refers to a person at that tenant organization who receives notifications from the security monitoring system whenever the security monitoring system identifies insider user behavior threats. Administrators typically have at least some responsibility and/or authority to assess and respond to such notifications. An administrator for a particular tenant organization may personally take one or more of these steps and/or may delegate one of more of the steps to others at the tenant organization.

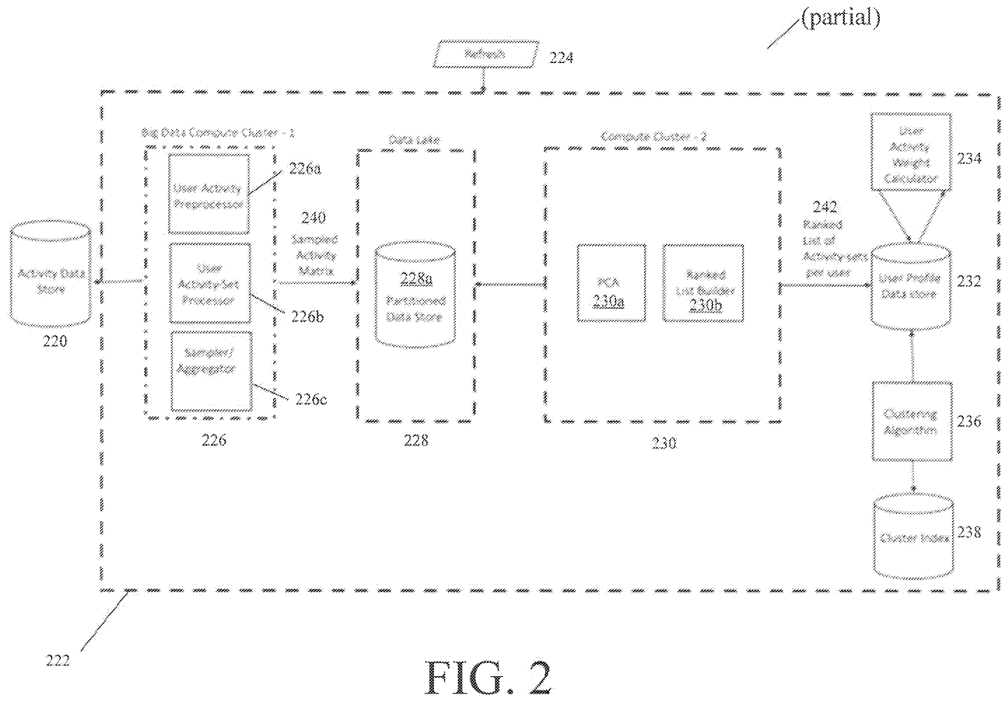

FIG. 2 is a schematic representation showing an implementation of a cloud data architecture that includes certain components of the security monitoring system 200 deployed on the network 100 of FIG. 1.

The illustrated cloud data architecture includes several components including an activity data store 220, a subassembly 222 of other components. A refresh indicator 224 is shown for subassembly 222. The subassembly 222 of components includes a big data compute cluster-1 (224), a data lake 228, a compute cluster-2 (230), a user profile data store 232, a user activity weight calculator 234, a clustering algorithm component, 236, and a cluster index data store 238. The big data compute cluster-1 (226) includes a user activity preprocessor 226a, a user activity-set processor 226b, and a sampler/aggregator 226c. The data lake 228 includes a partitioned data store 228a. The computer-cluster-2 (230) includes a principal component analysis (PCA) component 230a and a ranked list builder 230b.

In a typical implementation, the components in the illustrated cloud data architecture are configured to interact with (e.g., exchange data with) one other at least in accordance with the manner indicated by the connection lines that extend between components in the illustrated implementation. Thus, according to the illustrated implementation, the big data compute cluster-1 (226) is configured to interact with the activity data store 220 and with the data lake 228, the compute cluster-2 (230) is configured to interact with the data lake 228 and with the user profile data store 232. The user profile data store 232 is configured to additionally interact with the user activity weight calculator 234 and the clustering algorithm component 236, and the cluster index data store 238 is configured to interact with the clustering algorithm component.

In a typical implementation, the data stores (e.g., activity data store 220, partitioned data store 228a, user profile data store 232) and the cluster index 238 are implemented using one or more computer memory devices deployed somewhere on the computer network 100. In some implementations, the data store and cluster index components of the security monitoring system 200 may be implemented at the remote security monitoring platform 106. In some implementations, the data store and cluster index components may be distributed across the computer network 100 (e.g., with one or more being implemented at the remote security monitoring platform 106 and one or more being implemented at a corresponding one or more of the tenant networks 114a, 114b, 114c).

In a typical implementation, the other components of the security monitoring system 200 represented in FIG. 2 (“processing components”) may be implemented using one of more computer hardware components (e.g., computer processors) executing computer readable instructions that are stored on computer-readable media (e.g., hardware memory in the form of RAM, ROM, etc.) to perform computer-implemented functionalities associated with those components, as described herein. The processing components include the big data compute cluster-1 (226), including its subcomponents (226a, 226b, 226c), compute cluster-2 (230), including its subcomponents (230a, 230b), the user activity weight calculator 234, and the clustering algorithm component 236. In some implementations, these processing components of the security monitoring system 200 may be implemented at the remote security monitoring platform 106. In some implementations, the processing components may be distributed across the computer network 100 (e.g., with one or more being implemented at the remote security monitoring platform 106 and one or more being implemented at a corresponding one or more of the tenant networks 114a, 114b, 114c).

In a typical implementation, the system of FIG. 2 operates in accordance with the following exemplary computer-implemented processes. Much of the following description is specific to a particular one of the tenants (e.g., Tenant A). It should be understood, however, that comparable processes would be applicable to all the tenants in a multitenant SaaS environment.

According to an exemplary implementation, the security monitoring system 200 collects data (including, for example, user activity data and metadata about the user activity data) relating to user activities at the endpoint devices 102a-102l on the computer network 100. Moreover, in a typical implementation, the endpoint agent 350 of the security monitoring system 200 collects and timestamps user activity data and associated metadata. The data collected can be from any one or more of a variety of different sources and/or channels on the computer network 100 including, for example, operating systems (e.g., at endpoint 102a), applications (e.g., at the endpoint 354), connection-oriented communication sessions, a cloud access security broker (CASB), etc. Typically, the data is collected in an ongoing (e.g., continuous, periodic, sporadic, etc.) manner over an extended period of time (e.g., days, weeks, months, years, etc.) at each respective one of the endpoints 102a-102k on the computer network 100. The collected data typically is timestamped as well.

The collected data (e.g., user activity data and metadata) can include, for each respective one of the user activities that happen at an endpoint, one or more of the following (as applicable): internet protocol (IP) addresses, names of running applications, open window names, file names, file source locations, file destination locations (if being moved), geolocation information, website names and/or uniform resource locators (URLs) accessed, text (e.g., typed, edited, copied/pasted), commands entered, scripts run, mouse clicks made, visual records data (e.g., screenshots and/or screencasts) showing on-screen views of exactly what a user has done at a particular endpoint device, session durations, login accounts, system names, far endpoints a user came in from, numbers of slides, links, titles, process names, USB insertions, file cuts, file copies, file pastes, print jobs, etc. In a typical implementation, the collected data (e.g., user activity data and metadata) includes timestamps.

According to the process represented in the illustrated flowchart, the system 200 (at 404) stores all the data it collects, including timestamped user activity data and metadata, in the activity data store 220. The activity data store 220 can be cloud-based, in the associated endpoint (e.g., 102a), or distributed across multiple network locations.

In an exemplary multitenant SaaS security monitoring system environment where the activity data store 220 is implemented with (or as) one or more cloud data stores to record each tenant's user activities, for example: data is collected and stored all the tenants T on the network (e.g., 100 in FIG. 1). Typically, every tenant has users {u₁, u₂, u₃, . . . uₙ}, the users uₙ perform activities {a₁, a₂, a₃, . . . aₙ} represented by user activity data, and every activity aᵢ has an associated timestamp tsᵢ, associated metadata: {m₁, m₂, m₃, . . . mₙ}, and associated user information uiᵢ identifying the user that performed the corresponding user activity. Typically, data is added to the activity data store 220 in an ongoing manner such that the data stored in the activity data store 220 at any given point in time represents all of the data that has been collected by the system 200 from multiple endpoints (e.g., 102a-102l) on the network 100 over an extended prior period of time (e.g., immediately prior days, weeks, months, or even years).

Next, according to the exemplary implementation, the system 200 generates a sampled activity matrix 240. More specifically, in a typical implementation, the big data compute cluster-1 (226a) portion of the system 200 generates the sampled activity matrix. Typically, each sampled activity matrix that is generated will be based upon, and represent, at least some portion of the data that was stored in the activity data store 220 at the time that sampled activity matrix was generated. The sampled activity matrix typically forms a rectangular array (or “dataframe”) with numbers, for example, arranged in M rows and N columns, where M and N are positive whole numbers, and where each number in the array represents a property of the associated data from the activity data store 220.

In a typical implementation, each sampled activity matrix corresponds to (and, therefore, represents the user activities of) one, and only one, of the users: {u₁, u₂, u₃, . . . uₙ}. Thus, for a tenant that includes multiple users (e.g., {u₁, u₂, u₃, . . . uₙ}), the big data compute cluster-1 (226a) portion of the system 200 would generate multiple sampled activity matrices (e.g., one sampled activity matrix for each respective one of the multiple users (e.g., {u₁, u₂, u₃, . . . uₙ}).

In an exemplary implementation, each row in a sampled activity matrix represents one sample (e.g., one discrete period of time, such as one day) and each column corresponds to a particular activity-set. The phrase “activity-set” refers to an activity or a set of related activities that are performed together by a user at an endpoint within a certain amount of time (e.g., a few (2, 3, 4, 5, 6, 7, etc.) seconds or a few minutes) to accomplish a discrete task at the endpoint). Examples of related activities performed together by a user at an endpoint to accomplish a discrete task include activities sequences that include, for example, pressing Ctrl+C to copy a file from a source location and later pressing Ctrl+V to paste the file into a destination location on a personal computer. The number in each cell of a sampled activity matrix represents the number of times the corresponding activity-set was performed by the corresponding user during the corresponding period of time (e.g., on a given day).

More specifically, the steps involved in generating the sampled activity matrix 240 include querying the activity data store, preprocessing the user activity data, processing user activity sets, and sampling/aggregating. In a typical implementation, each of these steps is performed by the big data compute cluster-1 (226) and/or one of its sub-components (e.g., the user activity preprocessor 226a, the user activity-set processor 226b, or the sampler/aggregator 226c).

More specifically, in an exemplary implementation, the big data computer cluster-1 (226) queries the activity data store 220. The query may include one or more requests to retrieve one or more pieces of (or potentially all) the information collected and being stored in the activity data store 220 for one particular tenant. The activity data store 220, in response to the query, typically returns the requested data to the big data computer cluster-1 (226).

Next, the user activity preprocessor 226a in the big data computer cluster-1 (226) preprocesses the data that is returned by the activity data store. In various implementations, preprocessing may include, for example, filtering out certain data, or renaming some of the data or activities represented by the data, etc. In some implementations, the filtering out process may involve eliminating duplicates of particular pieces of data. In this regard, the user activity preprocessor 226a may compare the various pieces of data (user activity data and associated metadata, user information, and/or timestamps) to identify matches. If any matches are identified, the user activity preprocessor 226a may delete all but one matching data entries. In some implementations, the filtering out process may involve filtering out user activity data that is not deemed relevant to insider threat risk. In this regard, the user activity preprocessor 226a may review the various pieces of data (user activity data and associated metadata, user information, and/or timestamps) for one or more hallmarks indicating irrelevance to insider threat risk. These hallmarks may be stored in computer memory and referenced to perform the indicated review. Any pieces of data identified by the user activity preprocessor 226a as irrelevant (e.g., having one or more of the hallmarks indicating irrelevance) may be deleted, or flagged for exclusion from subsequent processing, by the user activity preprocessor 226a. In some implementations, the renaming may involve renaming to improve consistency of compliance with standard name formatting protocols, and/or improving the accuracy and/or descriptiveness of names to represent the associated data or activities. These preprocessing steps result in a preprocessed data set.

Next, according to an exemplary implementation, the sampler/aggregator 226c of the big data compute cluster-1 (226) samples the preprocessed data set, performs aggregation and creates one sampled activity matrix for each respective one of the users at the corresponding tenant. For example, in a typical implementation, user activity data is stored along with its timestamp that identifies when it occurred. For example, it could look like this (e.g., in computer memory)—{Bob, Web Upload, Epoch_1666275900}, which would indicate that a user named “Bob” did a web upload activity at 2:25 PM on Oct. 20, 2022. Typically, all such activities for all users may be timestamped and stored in this manner. The sampling step processes all such data over N preceding days and samples (e.g., groups) them into 1-Day intervals. For each day, the count of all activity-sets are aggregated for every user resulting in a sampled activity matrix similar to the example listed here.

An example of a sampled activity matrix for a fictional user (e.g., “Bob”) at one of the tenants (e.g., Tenant A) on network 100 follows:

| | activi- | activi- | activi- | activity_class_4 + |
|---|---|---|---|---|
| | ty_class_1 | ty_class_2 | ty_class_3 | activity_class_5 |
| day₁ | 2 | 19 | 1 | 2 |
| day₂ | 2 | 21 | 2 | 18 |
| day₃ | 2 | 20 | 1 | 11 |
| . . . | . . . | . . . | . . . | . . . |
| dayₙ | 2 | 23 | 3 | 12 |

The foregoing exemplary sampled activity matrix forms a rectangular array with numbers arranged in N rows (day₁, day₂, day₃, . . . dayₙ) and four columns (activity_class_1, activity_class_2, activity_class_3, and activity_class_4+activity_class_5). Each row represents one particular day (and is labeled as such), and each column represents a particular class of activity or combination of activity classes performed within some predetermined amount of time (e.g., 2, 3, or 4 seconds) of one another (and is labeled as such).

In a typical implementation, the big data compute cluster-1 (226) identifies occurrences to be represented in the sampled activity matrix by identifying individual user activities represented within the user activity data having similar characteristics as (and for inclusion in) each respective one of the activity classes. For activity_class_4+activity_class_5 column, the big data compute cluster-1 (226) may identify a pair of individual user activities that respectively match features associated with activity_class_4 and activity_class_5 features and determine whether that pair of user activities happened within a designated amount of time (e.g., within 2, 3, 4, or 5 seconds) of one another, based on respective timestamp data for the associated user activities.

In the exemplary sampled activity matrix (above), each number in the array represents the number of times that Bob performed a user activity that corresponds to a corresponding one of the activity classes on a corresponding one of the days at an endpoint (e.g., 102a) of network 100. Thus, as an example, and according to the illustrated sampled activity matrix, on day₁, Bob would have performed an activity falling within activity_class_1 twice, an activity falling within activity_class_2 nineteen times, an activity falling within activity_class_3 once, and an activity combination falling within activity_class_4+activity_class_5 twice. As another example, and according to the illustrated sample activity matrix, Bob would have performed an activity falling in activity_class_2 nineteen times on day₁, twenty one times on day₂, twenty times on day₃, and twenty three times on dayₙ.

Next, in an exemplary implementation, the sampled activity matrix for every user on the network is stored in the partitioned data store 228a on a cloud-based data lake 228. A partition is a division of a logical database (here, data store 228a) or its constituent elements into distinct independent parts. In various implementations, the partitioning can be done by either building separate smaller databases (each with its own tables, indices, transaction logs, and or sample activity matrices), or by splitting selected elements within the database. In an exemplary implementation, the sample activity matrices (240) are partitioned at least according to tenant with sample activity matrices for tenant A being partitioned from sample activity matrices for tenants B and C, with sample activity matrices for tenant B being partitioned from sample activity matrices for tenants A and B, and with sample activity matrices for tenant C being partitioned from sample activity matrices for tenants A and B. Thus, in a typical implementation, the sample activity matrices for every active user on the network is stored in the partitioned data store 228a and partitioned by tenant. In some implementations, additional (or different) partitioning schemes may be implemented as well. In a typical implementation, the data lake 228 is a cloud-based data lake.

Next, according to the illustrated flowchart, the system 200 generates a ranked list of activity sets 242 for each user. In a typical implementation, the ranked list of activity sets 242 ranks the user activities performed by the user (e.g., in order of relative variance). More specifically, to generate a ranked list of activity sets for a particular user (e.g., Bob), compute cluster-2 (230) queries the data lake 228 for the sampled user activity matrix for that particular users. The compute cluster-2 (230) then applies Principal Component Analysis (at PCA component 230a) to project the data from the sampled activity matrix for that particular user into N dimensions, where N is the number of columns (e.g., features or activity-sets) in the matrix.

After projecting the data for each user into N dimensions and correlating the features with the dimensions, the features are sorted (e.g., by the ranked list builder 230b) in the order of their relative variance (lowest variance feature is at the top). This ranked list of activity-sets per user is stored in the User Profile Data Store 232. For example, using a reduced snapshot of the dataset, a ranked list of activity sets 242 for a user, “Bob,” may look like this:

| activity | rank |
|---|---|
| activity_class_{_{—}}₁ | 1 |
| activity_class_2 | 2 |
| activity_class_3 | 3 |
| activity_class_4 | 4 |
| activity_class_5 | 5 |
| activity_class_11 + activity_class_12 | 6 |

According to the foregoing exemplary ranked list of user activities, activity_class_1 has the lowest variance, activity_class_2 has the next lowest variance, activity_class_3 has the next lowest variance, activity_class_4 has the next lowest variance, activity_class_5 has the next lowest variance, and activity_class_11+activity_class_12 has the highest variance. In general, variance is a measure of dispersion, meaning it is a measure of how far a set of numbers is spread out from their average value. More specifically, in an exemplary implementation, variance refers to an expected value of the squared deviation of a random variable from its population mean or sample mean, for example.

Thus, in an exemplary implementation, PCA projects the sampled activity matrix into n dimensions (n principal components) where n equals the number of activity-sets (columns) in the sampled activity matrix for each user. Each of these dimensions (components) correlate with a column (activity-set) in the matrix. The first principal component is the direction in space along which projections have the largest variance and the last principal component is the direction in space along which projections have the least variance. By correlating the dimensions (principal components) with the activity-sets (columns of the matrix) and sorting them such that the least variance activity-set is at the top we create a ranked list of activity-sets for each user based on the relative variance of their activity-sets.

Moreover, in an exemplary implementation, the dataframe D created above is projected into N dimensions using Principal Component Analysis, where N is the number of activity-sets (also referred to as features interchangeably). The features of each user are then ranked relative to each other using the projected dimensions with the feature that correlates the most with the direction of the least variance ranked the highest in the list, and the feature that correlates the most with the direction of the highest variance ranked the lowest in the list. Each user in the tenant typically would have a list of features ranked in this way. This ranked list of features is stored in a behavior profile of the user (e.g., in the user profile data store 232). Thus, each user in the tenant would have a list of features ranked according to their relative variance depending on their past behavior. This list may be denoted (and labeled in the user profile data store 232, for example) as L.

Next, in an exemplary implementation, the system 200 clusters similar users based on their respective user activities. In this regard, the list L created above consists of activity-sets (features) that are ranked in the ascending order of their relative variance for a given user. From this list L, the system 200 creates another list Lᵣ which is the same as list L, except sorted in a descending order, i.e., the reverse of L. This reverse list Lᵣ also may be saved (and labeled as such) in the user profile data store 232. Thus, each user in the tenant ends up with two ranked lists L and Lᵣ. In a typical implementation, each of the two ranked list L and Lᵣ may get stored by the system 200 in the user profile data store 232.

Next, in an exemplary implementation, the system 200 calculates two similarity scores, Sₐ and S_{b} between each pair (combination) of users in the tenant. Both the similarity scores are computed using the Rank Biased Overlap (RBO) algorithm with the tunable parameter p that determines the contribution of the top d ranks to the final value of the similarity measure (so called “top-weightiness”). Sₐ is calculated using aforementioned list L, while S_{b} is calculated using the aforementioned reverse list Lᵣ. Thus, Sₐ reflects the similarity between two users in terms of their low variance activity snapshot while S_{b} reflects the similarity between two users in terms of their high variance activity snapshot. In some implementations, these similarity scores Sₐ, S_{b} for each pair of users may be stored in in the user profile data store 232. The example below shows the ranked feature lists of two users and their similarities calculated using the Rank Biased Overlap (RBO) algorithm by adjusting the value of “top-weightiness” (p).

| | | |
|---|---|---|
| f1 | f1 | rbo.similarity(p = 0.4) = 0.9942, |
| f2 | f2 | rbo.similarity(p = 0.8) = 0.7629 |
| f3 | f3 | |
| f4 | f4 | |
| f5 | f7 | |
| f6 | f5 | |
| f7 | f6 | |

RBO is an intersection based technique (that can be implemented by the system 200) to measure similarity between two non-conjoint lists (as above). Non-Conjoint lists are lists where certain items could be present in only one of them. At a high level, the system 200 may count the number of overlapping items between the two lists at each level (depth) in the lists. In other words, at each depth “d” an “overlap” is measured which is the ratio between the intersection and union of the two lists. The average overlap at depth d is the mean of all the d overlaps so far. The final average overlap at the end of the lists is the similarity measure between the two lists. The system 200, in a typical implementation, also adjusts the top-weightiness parameter (denoted as p) while measuring the similarity. In some instances, by adjusting the value of p the system 200 can determine how much the similarity at the top of the two lists should weigh compared to the similarity at the bottom of the two lists.

Subsequently, in an exemplary implementation, the system 200 uses the similarity scores Sₐ, S_{b} between each pair of users in the tenant to create two similarity matrices: SMₐ (using Sₐ) and SM_{b} (using S_{b}). In this way, user similarity matrices SMₐ and SM_{b} between each pair of users (e.g., u₁, u₂) in the tenant is created. The RBO algorithm tends to be top biased, which means similarities at the top of the lists tend to contribute more towards the similarity score(s). To offset this bias, the system 200 inverses the list queried from the user profile store and creates a second user similarity matrix using the inversed list L_{R}. Thus, in the case of comparing two users using their list L and adjusting the value of p, the system 200 is effectively measuring the similarity between two users by giving more attention to their low variance activity footprint. And in the case of comparing two users using their inversed list the system 200 gives more attention to their high variance activity footprint. In a typical implementation, user similarity matrices SMₐ and SM_{b} may get stored by the system 200 in the user profile data store 232.

Next, in an exemplary implementation, the system 200 computes a final similarity matrix SM. This final similarity matrix SM may be computed as the mean of SMₐ and SM_{b}. In some implementations, the two similarity matrices SMₐ and SM_{b}, as well as the final similarity matrix SM are stored in the user profile data store 232. The final user similarity matrix SM essentially represents a mean of the above two matrices SMₐ and SM_{b}. In a reduced example, in a tenant, a final user similarity matrix SM may look as follows:

| | Bob | Alice | Carol | Eve |
|---|---|---|---|---|
| Bob | 1.0 | 0.91 | 0.43 | 0.39 |
| Alice | 0.91 | 1.0 | 0.29 | 0.36 |
| Carol | 0.43 | 0.29 | 1.0 | 0.92 |
| Eve | 0.39 | 0.36 | 0.92 | 1.0 |

The foregoing exemplary final user similarity matrix SM provides measures of similarity between the user activities for each pair of identified users in the same tenant—Bob, Alice, Carol, and Eve. Each one of the similarity score rows in the final user similarity matrix SM corresponds to a particular one of the identified users (who are identified in the far left column of the matrix). Likewise, each one of the similarity score columns in the final user similarity matrix SM corresponds to a particular one of the identified users (who are identified in the top row of the matrix). The similarity score in each cell of the final user similarity matrix SM provides a measure of similarity between the user identified for that cell's row and the user identified for that cell's column.

The similarity scores in the illustrated final user similarity matrix SM can range between 0.00 and 1.0, with 0.00 indicating no similarity at all and 1.0 indicating complete similarity. Thus, the higher the value, the more similar the two users' activities were. For example, according to the exemplary final user similarity matrix SM, Bob and Alice are highly similar (with a similarity score of 0.91), and Carol and Eve are highly similar (with a similarity score of 0.92). On the other hand, Carol, and Alice, for example, are quite dissimilar (with a similarity score of 0.29).

In a typical implementation, final user similarity matrix SM may get stored by the system 200 in the user profile data store 232.

Finally, the system 200 applies spectral clustering to the final user similarity matrix SM to create two or more groups (or clusters) of users in the tenant, grouped or clustered according to the similarity scores in a final user similarity matrix SM. More specifically, in a typical implementation, the clustering algorithm component 236 of the system 200 applies the spectral clustering to the similarity matrix SM to create the clusters of users.

In an exemplary implementation, using the user similarity matrix, spectral clustering computes graph partitions such that connected graph components are inferred as clusters. The graph is partitioned in such a way that the edges between different clusters have smaller weights compared to edges within the same cluster that have higher weights. At a high level, the steps (performed by system 200) are as follows: 1. construct a degree matrix (D) and a Laplacian matrix (L) from the similarity matrix, 2. from L, compute the eigenvalues and the eigenvectors, 3. get the k largest eigenvalues and their eigenvectors, 4. construct a matrix from the k eigenvectors created above, and 5. normalize the matrix and cluster the points.

Ultimately, from the spectral clustering process, each user gets assigned to a particular one of two or more (or many) clusters. Each cluster typically is identified by a unique cluster identifier, cluster_{id}. In an exemplary reduced dataset, four users in a tenant may be organized into clusters as follows:

| User | Cluster_{id} |
|---|---|
| Bob | 0 |
| Alice | 0 |
| Carol | 1 |
| Eve | 1 |

According to the table above, Bob and Alice (who were identified above as having a high similarity score of 0.91) end up being assigned to one cluster (having a cluster_{id} of 0) and Carol and Eve (who were identified above as having a high similarity score of 0.92) are in another cluster (having a cluster_{id} of 1).

In a typical implementation, the system 200 saves the cluster assignment table above, which includes the cluster_{id} assignments for each user in the tenant, in the cluster index 238.

Next, according to an exemplary implementation, the user activity weight calculator module 234 queries the user profile data store 232 and computes a weight Wᵢ for each activity-set for every user in the tenant using the ranked list of the activity-sets of the user as follows and stores the resulting score in the user profile store 232:

$$weights = \{ max\_score * x / N for x in range ( 1 , N + 1 ) \}$$

$$weights = sorted ( scores , reverse = True )$$

(Here N is the length of the list)

Moreover, when the user activity weight calculator component 234 queries the user profiles created above it gets the ranked list of features L for every user. The system 200 may assign a normalized weight Wᵢ to each activity-set in the list for every user—the highest weight/score assigned to the activity-set at the top of the list L (i.e., the activity-set with the least relative variance gets the highest score). Thus, each activity-set for every user in the tenant has a weight associated with it and this is stored in the user profile data-store.

In a reduced dataset, for example, user Bob's activity-set weights may look like:

| activity | weight |
|---|---|
| activity_set_1 | 0.85 |
| activity_set_2 | 0.71 |
| activity_set_3 | 0.57 |
| . . . | . . . |
| activity_set_n | 0.18 |

In a typical implementation, the system 200 saves the foregoing information (e.g., the table, including the calculated weights in the table), in the user profile data store 232.

In a typical implementation, the system 200 (as represented by the refresh trigger 224) triggers the above pipeline (e.g., 222 in FIG. 2) at various intervals. The intervals may be regular, irregular, periodic, etc. This refresh cycling helps to keep the scores and user clusters fresh. The refresh trigger 224 may be on a timer, may be based on a count of new user activities recorded, etc.

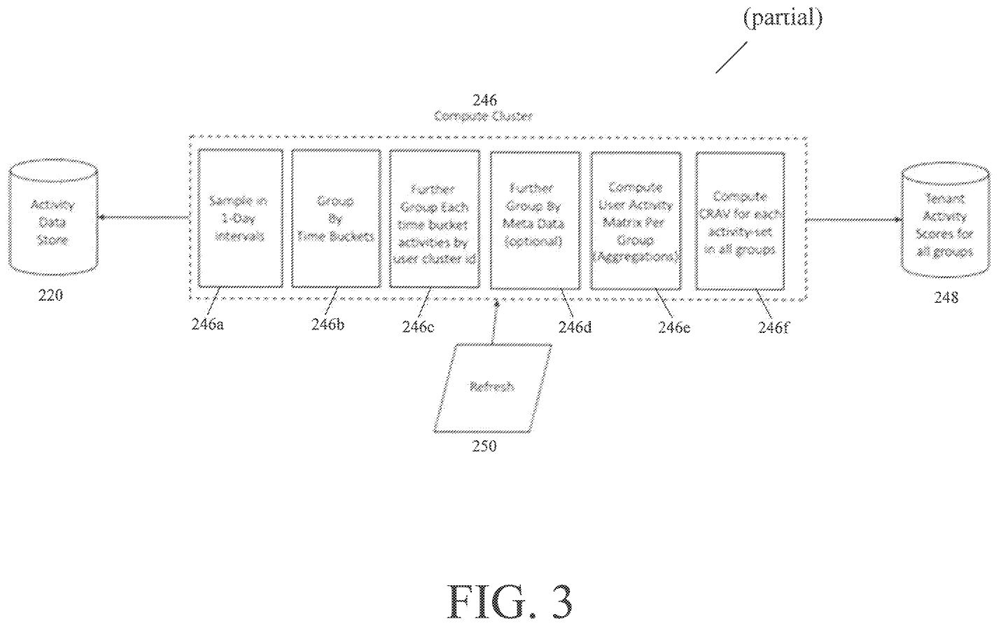

Next, referring now to FIG. 3, the system 200, in an exemplary implementation, ranks and scores user activities across a particular tenant (e.g., tenant A). FIG. 3 is a schematic representation showing an exemplary high-level overview of the architecture (e.g., components and subcomponents) for this. The illustrated architecture includes the activity data store 220 (discussed above), a compute cluster component 246, a tenant activities scores for all groups data store 248, and a refresh trigger 250 for the illustrated pipeline. The activity data store 220 in the illustrated implementation is configured to interact with the compute cluster component 246 as indicated, the compute cluster component 246 is configured to interact with the tenant activities scores for all groups data store 248 as indicated, and the refresh trigger 250 is configured to interact with the compute cluster 246 as indicated.

The compute cluster 246 includes components directed to sampling data in 1-day intervals 246a, grouping data by time buckets 246b, further grouping the data grouped by time bucket by user cluster ids 246c, further grouping by metadata 246d (which is optional), computing a user activity matrix per group (aggregating) 246e, and computing Contextual Relative Activity Variance (“CRAV”) for each activity set in all groups component 246f. In a typical implementation, the components of the security monitoring system 200 represented in FIG. 3 (and otherwise disclosed herein), especially in the compute cluster 246, may be implemented using one of more computer hardware components (e.g., computer processors) executing computer readable instructions that are stored on computer-readable media (e.g., hardware memory in the form of RAM, ROM, etc.) to perform computer-implemented functionalities associated with those components, as described herein. In some implementations, these processing components of the security monitoring system 200 may be implemented at the remote security monitoring platform 106. In some implementations, the processing components may be distributed across the computer network 100 (e.g., with one or more being implemented at the remote security monitoring platform 106 and one or more being implemented at a corresponding one or more of the tenant networks 114a, 114b, 114c).

In a typical implementation, the compute cluster 246 queries the activity data store 220 for user activity data. More specifically, in the illustrated implementation, the query requests a 1-day interval of user activity data (via 246a) for one entire tenant (e.g., tenant A). The activity data store 220 responds to the query by returning the requested data to the compute cluster 246. Next, the compute cluster 246 groups the returned data in various ways.

In particular, according to the illustrated implementation, the compute cluster 246 groups the returned data into time buckets (e.g., morning, afternoon, evening, night, etc.). This grouping may be performed based on timestamping information in the returned data and designated time periods that correspond to each of period of time. Thus, if a particular piece of data has a timestamp indicating the corresponding user activity took place at 9:30 am (and the designated time period for “morning” encompasses 9:30 am), then the compute cluster 246 groups that particular piece of data into a morning time bucket (and optionally tags that piece of data as such). Likewise, if another piece of data has a timestamp indicating the corresponding user activity took place at 11:30 pm (and the designated time period for “night” encompasses 11:30 pm), then the compute cluster 246 groups that particular piece of data into a morning time bucket (and optionally tags that piece of data as such).

Next, in the illustrated implementation, the data in each respective time bucket is further grouped by user clusters (at 246c). This further grouping may be based on the cluster_{id} assignments for each user in the tenant, computed using methods disclosed herein. Assume, for purpose of the illustrated that users Bob, Alice, and Eve, for example, belong to a first cluster (as defined by a first cluster_{id}), and users Carol and Dave belong to a second cluster (as defined by a second cluster_{id}). In that case, the compute cluster 246 would group all the data for activities by Bob, Alice, and Eve within each respective time period (e.g., morning) into a first cluster bucket for that time period (and optionally tag the data as such). Moreover, in that case, the compute cluster 246 would group all the data for activities by Carol and Dave within each respective time period (e.g., morning) into a second cluster bucket for that time period. In this example, at the end of the further grouping in 246c, there might be multiple time/cluster buckets including: 1) a first cluster_{id} morning bucket (with user activity data for activities by Bob, Alice, and Eve that happened during the morning on the particular 1-day interval), and 2) a second cluster_{id} morning bucket (with user activity data for activities by Carol and Dave that happened during the morning on the particular 1-day interval). Other buckets or groups would exist too and may be stored in computer memory on the system 246.

Next (and optionally), in the illustrated implementation, the data in each respective time/cluster bucket is further grouped by metadata (at 246d). In a typical implementation, at the end of this further grouping in 246d, there might be multiple time/cluster/metadata buckets.

The foregoing processes (including sampling (via 246a) and any combination of 246b, 246c, and/or 246d) may be repeated for user activity data for each respective one of multiple days. After grouping the user activity data for multiple X days, the compute cluster 246 (via 246e) aggregates the grouped user activity data over the X days to create grouped user activity matrices—where each cell Cᵢⱼ in a matrix is the sum of frequency of a user activity (or activity-setⱼ) for a user (userᵢ) in a particular time period (e.g., morning), aggregated over X days. For example, in a reduced dataset, grouped user activity matrices for a tenant may look like these:

user_activity_matrix_cluster_{2—}morning

| | activi- | activi- | activi- | activi- |
|---|---|---|---|---|
| | ty_set₁ | ty_set₂ | ty_set₃ | ty_set₄ |
| bob | 2 | 10 | 25 | 11 |
| alice | 3 | 10 | 27 | 7 |
| eve | 5 | 9 | 31 | 10 |

user_activity_matrix_cluster_{0—}evening

| | activi- | activi- | activi- | activi- |
|---|---|---|---|---|
| | ty_set₁ | ty_set₂ | ty_set₃ | ty_set₄ |
| carol | 10 | 2 | 11 | 14 |
| dave | 9 | 1 | 10 | 10 |

Each cell in the first of the above matrices (user_activity_matrix_cluster₂_morning) shows a sum of the frequency of a corresponding user activity (activity-set₁, activity-set₂, activity-set₃, activity-set₄) for a corresponding user (Bob, Alice, or Eve) in a particular cluster (defined by cluster id, cluster₂) in a particular time period (e.g., morning), aggregated over X days. Similarly, each cell in the second of the above matrices user_activity matrix_cluster₀_evening) shows a sum of the frequency of a corresponding user activity (activity-set₁, activity-set₂, activity-set₃, activity-set₄) for a corresponding user (Carol or Dave) in a particular cluster (defined by cluster id, cluster₀) in a particular time period (e.g., evening), aggregated over X days. In a typical implementation, the grouped user activity matrices and underlying data may be stored in computer memory with the system 200.

Next, according to the illustrated implementation, the compute cluster 246 may rank and/or score user activities across multiple groups in a tenant. In an exemplary implementation, the compute cluster 246, using the CRAV scoring formula discussed above computes activity scores in each grouped user activity matrix and stored in the data store. More specifically, in an exemplary implementation, the compute cluster 246 computes a score (referred to as a CRAV) for the activity-sets in each grouped user activity matrix. In such implementations, each group G is defined by the time buckets and the cluster_{id} (and, optionally, other meta data fields). Each matrix M in group G has N rows and P columns, where N represents the number of users in a group and P represents the number of activity-sets in a group. The Contextual Relative Activity Variance for each activity-setⱼ in each matrix group G may be computed, by the compute cluster 246, as follows:

$${CRAV}_{{j}_{j ∈ P}} = \frac{( N * [ 1 + log ( 1 + {σ}^{2} ( \vec{v} ) ) ) ]}{{\sum }_{i = 1}^{N} {C}_{ij}}$$

where Cᵢⱼ corresponds to the value in the user activity matrix for userᵢ and

$$activity - {set}_{j} , \vec{v} = \{ {C}_{1 j} ,$$

C₂ⱼ, . . . , C_{Nj}}.

In a reduced dataset example, the scores may look like, for example:

activity_scores_cluster_{2—}morning

| activity | score |
|---|---|
| activity_set₁ | 0.456 |
| activity_set₂ | 0.115 |
| activity_set₃ | 0.072 |
| activity_set₄ | 0.184 |

In a typical implementation, the scores and/or matrix is stored in computer memory (e.g., in a data store of system 200).

The foregoing tenant activity score computation pipeline (represented in FIG. 3) may be refreshed/triggered (see, e.g., refresh trigger 250) periodically to keep the scores fresh. This period can be a static interval or set dynamically based on a user activity event in the cloud SaaS infrastructure.

Next, in an exemplary implementation, the system 200 performs an inference process.

More specifically, during inference on a dayₘ, user activities may be aggregated in batch mode or streaming mode (both of which are discussed below) and a vector Vᵢ is computed for every userᵢ by matching the user and the time stamp of the activity-set to the closest group as defined above. Each element in the vector Vᵢ is the product of the aggregated frequency of the user's activity-set in a time window, the CRAV score of the activity-set (retrieved from the matched matrix group) and the weight Wᵢ of the activity-set retrieved from the user's profile. The score derived from this activity vector Vᵢ is then assigned to users and all the user scores in a group are normalized and sorted. A z-statistic is then computed for each user score and scores above a threshold are flagged as deviation from the group behavior during the time window. Alternatively, the user behavior vector is fed into a one class Support Vector Machine (SVM) algorithm to detect deviation of the user behavior from the group.

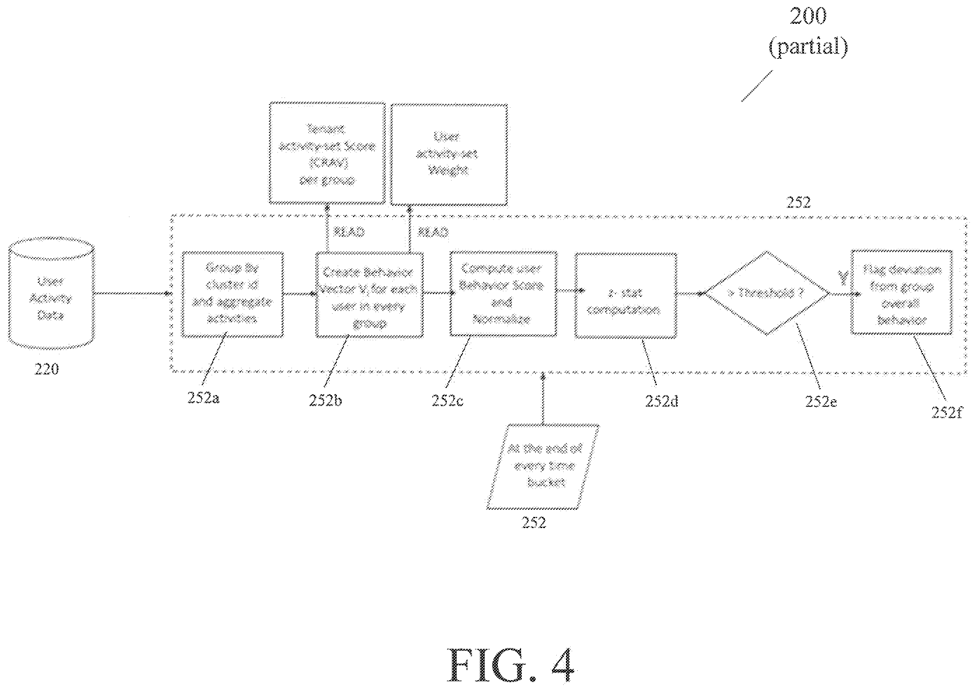

In this regard, FIG. 4 provides a high-level, schematic representation, overview of an exemplary architecture for system 200 in batch inference mode. Batch inference refers generally to computer-implemented processes that involve generating predictions based on a batch of observations, typically on some recurring schedule (e.g., hourly, daily, etc.)

The illustrated architecture includes the user activity data store 220, and a batch inference architecture 252 having several components respectively configured to: group (e.g., user activity data) by cluster id and aggregate activities 252a, create a behavior vector Vᵢ for each user in every group 252b, compute user behavior scores and normalize 252c, compute z-stat 252d, check whether threshold is exceeded 252e, and flag deviations from group overall behavior 252f. In the illustrated implementation, the component associated with creating a behavior vector Vᵢ for each user in every group 252b reads data previously established including data related to the tenant activity score (CRAV) per group (discussed above), and data related to user activity set weight (also discussed above). In an exemplary implementation, the data on batch inference tenant activity scores (CRAV) per group may be read from the tenant activity scores for all groups data store (e.g., 248 in FIG. 3), and the user activity set weight data may be read from the user profile data store (e.g., 232 in FIG. 2).

In batch mode, user score computation and comparison with similar users, for example, may be triggered (see, e.g., trigger 252) at the end of time buckets (e.g., morning, afternoon, etc.) as defined in the original matrix grouping discussed above. This trigger 252, therefore, may be keyed to a timer within the system 200.

During operation, the illustrated batch inference architecture 252 acquires user activity data from the user activity data store 220. The user activity data so acquired is grouped (at 252a) based on cluster ids assigned to the user activities represented by the user activity data for each time bucket (e.g., morning, afternoon, etc.). In some implementations, further grouping may be performed as well (e.g., grouping based on meta data associated with the user activity data, etc.). In a typical implementation, the user activity data may be aggregated as well, thereby producing a value that represents an aggregated frequency (e.g., number of occurrences of users' activity sets in each particular time bucket).

Next (at 252b), the batch inference architecture 252 creates a behavior vector Vᵢ for each user in every group that was just created. In a typical implementation, N behavior vectors Vᵢ are created per group, where N is the number of users in each group. Moreover, in a typical implementation, each behavior vector Vᵢ has a length of Kⱼ, where Kⱼ is the number of unique activity-sets of a userᵢ observed in a group. Note that Kⱼ may be different for each userᵢ. Each element in the vector Vᵢ is the product of the aggregated frequency Fⱼ of the user's activity-setⱼ in a particular time bucket, the CRAV score of the activity-setⱼ (retrieved from the matched user activity matrix group) and the weight Wⱼ of the activity-setⱼ retrieved from the user's profile. A user behavior score is computed (at 252c) in each group as follows:

$${Score}_{{i}_{i ∈ N}} = ( {\sum }_{j = 1}^{{K}_{j}} {F}_{j} * {CRAV}_{j} * {W}_{j} ) * \frac{1}{{K}_{j}}$$

where CRAVⱼ is the tenant activity score read from the matched group and Wⱼ is the weight of the activity read from the user's profile. The batch inference architecture 252 assigns the user behavior score(s) derived from activity vector(s) Vᵢ is to users (e.g., with assignment designation in computer memory). Moreover, in a typical implementation, the batch inference architecture 252 normalizes and sorts (e.g., in ascending or descending order) all the users, according to their respective user scores, in a group. Scores may be normalized within each group using min max normalization, where Score (userX)=(Score (userX)−Min Score in Group G)/(Max Score in Group G−Min Score in Group G).

Next, according to the illustrated implementation, the batch inference architecture 252 (at 252d) computes a z-statistic for each respective one of the user scores. In general, a z-statistic is a number that represents how many standard deviations above or below the mean of a population a particular value is. Essentially, it is a numerical measurement that describes a value's (e.g., a user's scores') relationship to the mean of a group of values (e.g., other users' scores). In an exemplary implementation, the z-statistic indicates how much a user score differs from the standard deviation of the user scores distribution of the group. It may be computed as z-score=(user score−mean user score of group)/(standard deviation of user scores in the group).

Next, the batch inference architecture 252 (at 252e) determines whether any of the z-statistics are above a threshold value (e.g., stored in computer memory). The batch system architecture 252 (at 252f) flags any user activities that have a z-statistic that exceeds the threshold as a deviation from group behavior during that time window.

Alternatively, the user behavior vector Vᵢ can be fed into a one class Support Vector Machine (SVM) algorithm to detect deviation of the user behavior from the group.

As an alternative to batch inference, the system 200 may utilize streaming inference mode to facilitate detection of user behavior deviations from a group.

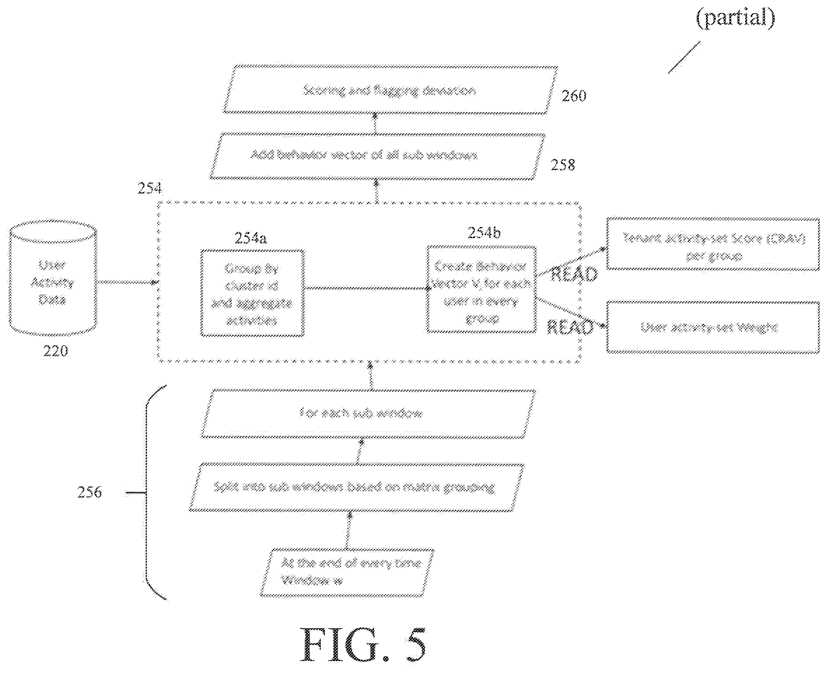

In this regard, FIG. 5 provides a high-level, schematic representation, overview of an exemplary architecture for system 200 in streaming (or real time) inference mode.

The illustrated architecture includes the user activity data store 220, a behavior vector calculator component 254 (with components for grouping by cluster id and aggregating activities (at 254a) and for creating behavior vectors Vᵢ for each user in every group (at 254b)), components for splitting into sub-windows (at 256), adding behavior vectors for all sub-windows (at 258), and scoring and flagging deviations (at 260). The component for creating the behavior vectors Vᵢ is configured to read certain data (e.g., from computer memory) including, for example, tenant activity-set score (CRAV) per group data, and user activity-set weight data.

Here, the score computation and comparison with similar users (by system 200) tends to be triggered at the end of regular shorter time windows w, where w is not the same as the time interval defined in the original matrix grouping and usually is less in duration compared to for example time-of-day based windows, such as morning, evening etc. In every time window w, user behavior vectors Vᵢ are created by the system 200 (at 254b) in every group (defined at (254a) and a behavior score is calculated similar to the method used in the batch inference mode. In the streaming mode the window w is mapped to an appropriate time bucket defined in the original matrix grouping to get the CRAV score. However, window w can overlap multiple time buckets defined in the original grouping. Overlapping windows are divided into multiple sub-windows by the system 200 (at 256) and each sub-window may be mapped to a time bucket. Thus, a behavior vector is created by the system 200 (at 258) for each sub-window. Multiple behavior vectors corresponding to sub-windows are added to get the final behavior vector, used by the system 200 for flagging deviations (at 260).

Original Grouping refers to the time bucket based grouping of the activity matrix. An exemplary implementation has a grouped activity matrix for each time bucket (e.g., morning, evening, etc.), from which the system computes an activity scores for that time bucket. For example, the morning session will have scores specific to the morning session, the evening session will have scores specific to the evening session and so on. In batch inference mode, inference may be triggered at the end of a defined time bucket. For example, in some implementations, at the end of a morning session, the system will trigger an inference. For this, the system may use the scores computed from the activity matrix of the morning session as defined above. As opposed to the batch inference mode where inference is triggered at the ends of time buckets, in streaming mode, the system applies windows of a defined interval on the streaming activity data. This is for real time inference use cases and, in some such instances, threats may be detected earlier than in batch inference mode. For example, let's say that the morning session is defined from 7:00 AM to 11:00 AM. In batch inference mode, the system will trigger the inference at (or about) 11:00 AM and use the scores from the activity matrix for the morning session. In streaming mode, the system will apply several windows between 7:00 AM to 11:00 AM. Let us assume that each window is 45 minutes. In this case, we could have a window applied from 7:30 AM to 8:15 AM—for this the system may look up the scores from the activity matrix for the morning session as the window falls well within the boundaries of the morning session. But it's possible that the system could apply a window from 10:45 AM to 11.30 AM. In this case 15 minutes overlaps with the morning session and the rest of the 30 minutes overlap the next session. Thus, in this example, there would be two sub windows. The system, therefore, would compute two behavior vectors—one computed using the scores from the morning session and the other from the noon session. Finally, the system would add these two vectors to come up with the final behavior vector for this interval.

Similar to the alternate method mentioned in the batch inference mode, the vectors can be fed into a one class SVM algorithm to detect outlier user behaviors in a group.

There are a variety of ways in which a deviation in a user's behavior (e.g., relative to others) identified by the system 200 may be flagged. In some cases, the flagging may occur by the system 200 producing an electronic message (e.g., an email, text, alert or note in an application environment, or on a web-based interface, etc.) directed to a person or persons in the corresponding tenant with responsibility and/or authority to address, investigate, and/or potentially take remedial action to rectify the user's behavior and/or the results thereof.

### Method to Detect Internal User Behavior Threats in a Multi-Tenant Software as a Service (SaaS) Security System by Comparing a User's Behavior to That of Their Own Past Behavior Pattern

This section of the disclosure focuses primarily on computer systems and computer-implemented techniques for detecting internal user behavior threats in a multi-tenant software as a service (SaaS) security system by comparing a user's behavior (e.g., a single user activity or single user activity-set) to that user's own prior behavior patterns (e.g., based on prior user activities and user activity-sets by that user).

The systems and techniques disclosed in this section may be deployed on the exemplary computer system 100 of FIG. 1 instead of (or as an alternative, in addition, to) the systems and techniques discussed above in connection with FIGS. 2-5 (where user behavior threats were detected by comparing user behavior to that of other users in the tenant) or as an alternative to the systems and techniques discussed above.

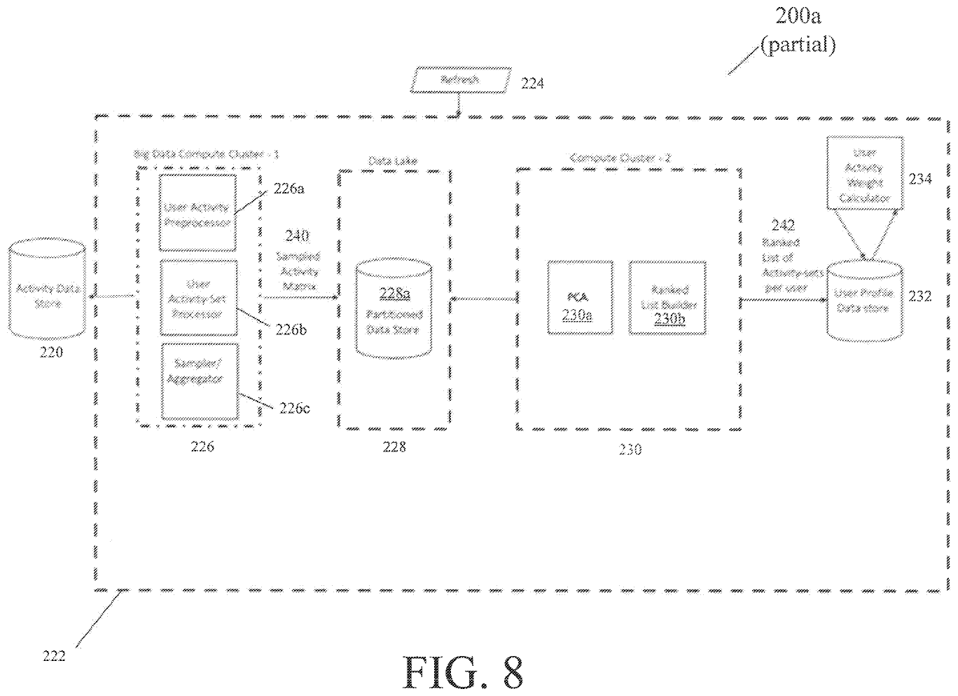

FIG. 8 is a schematic representation showing an implementation of a cloud data architecture that includes certain components of the security monitoring system 200a deployed on the network 100 of FIG. 1. The portion of the security monitoring system 200a represented in the cloud data architecture of FIG. 8 is the same as the portion of the security monitoring cloud system 200 represented in the cloud data architecture of FIG. 2, except that the portion of the security monitoring system 200a represented in FIG. 8 lacks the clustering algorithm component, 236, and the cluster index data store 238 (which are present in FIG. 2).

Thus, the illustrated cloud data architecture in FIG. 8 includes several components including an activity data store 220, a subassembly 222 of other components. A refresh indicator 224 is shown for subassembly 222. The subassembly 222 of components includes a big data compute cluster-1 (224), a data lake 228, a compute cluster-2 (230), a user profile data store 232, and a user activity weight calculator 234. The big data compute cluster-1 (226) includes a user activity preprocessor 226a, a user activity-set processor 226b, and a sampler/aggregator 226c. The data lake 228 includes a partitioned data store 228a. The computer-cluster-2 (230) includes a principal component analysis (PCA) component 230a and a ranked list builder 230b.

In a typical implementation, the components in the illustrated cloud data architecture are configured to interact with (e.g., exchange data with) one other at least in accordance with the manner indicated by the connection lines that extend between components in the illustrated implementation. Thus, according to the illustrated implementation, the big data compute cluster-1 (226) is configured to interact with the activity data store 220 and with the data lake 228, the compute cluster-2 (230) is configured to interact with the data lake 228 and with the user profile data store 232. The user profile data store 232 is configured to additionally interact with the user activity weight calculator 234.

In a typical implementation, the data stores (e.g., activity data store 220, partitioned data store 228a, user profile data store 232) are implemented using one or more computer memory devices deployed somewhere on the computer network 100. In some implementations, the data store x components of the security monitoring system 200a may be implemented at the remote security monitoring platform 106. In some implementations, the data store components may be distributed across the computer network 100 (e.g., with one or more being implemented at the remote security monitoring platform 106 and one or more being implemented at a corresponding one or more of the tenant networks 114a, 114b, 114c).

In a typical implementation, the other components of the security monitoring system 200a represented in FIG. 8 (“processing components”) may be implemented using one of more computer hardware components (e.g., computer processors) executing computer readable instructions that are stored on computer-readable media (e.g., hardware memory in the form of RAM, ROM, etc.) to perform computer-implemented functionalities associated with those components, as described herein. The processing components include the big data compute cluster-1 (226), including its subcomponents (226a, 226b, 226c), compute cluster-2 (230), including its subcomponents (230a, 230b), and the user activity weight calculator 234. In some implementations, these processing components of the security monitoring system 200a may be implemented at the remote security monitoring platform 106. In some implementations, the processing components may be distributed across the computer network 100 (e.g., with one or more being implemented at the remote security monitoring platform 106 and one or more being implemented at a corresponding one or more of the tenant networks 114a, 114b, 114c).

In a typical implementation, the system of FIG. 2 operates in accordance with the following exemplary computer-implemented processes. Much of the following description is specific to a particular one of the tenants (e.g., Tenant A). It should be understood, however, that comparable processes would be applicable to all the tenants in a multitenant SaaS environment.

According to an exemplary implementation, the security monitoring system 200a collects data (including, for example, user activity data and metadata about the user activity data) relating to user activities at the endpoint devices 102a-102l on the computer network 100. Moreover, in a typical implementation, the endpoint agent 350 of the security monitoring system 200a collects and timestamps user activity data and associated metadata. The data collected can be from any one or more of a variety of different sources and/or channels on the computer network 100 including, for example, operating systems (e.g., at endpoint 102a), applications (e.g., at the endpoint 354), connection-oriented communication sessions, a cloud access security broker (CASB), etc. Typically, the data is collected in an ongoing (e.g., continuous, periodic, sporadic, etc.) manner over an extended period of time (e.g., days, weeks, months, years, etc.) at each respective one of the endpoints 102a-102k on the computer network 100. The collected data typically is timestamped as well.

The collected data (e.g., user activity data and metadata) can include, for each respective one of the user activities that happen at an endpoint, one or more of the following (as applicable): internet protocol (IP) addresses, names of running applications, open window names, file names, file source locations, file destination locations (if being moved), geolocation information, website names and/or uniform resource locators (URLs) accessed, text (e.g., typed, edited, copied/pasted), commands entered, scripts run, mouse clicks made, visual records data (e.g., screenshots and/or screencasts) showing on-screen views of exactly what a user has done at a particular endpoint device, session durations, login accounts, system names, far endpoints a user came in from, numbers of slides, links, titles, process names, USB insertions, file cuts, file copies, file pastes, print jobs, etc. In a typical implementation, the collected data (e.g., user activity data and metadata) includes timestamps.

According to the process represented in the illustrated flowchart, the system 200a (at 404) stores all the data it collects, including timestamped user activity data and metadata, in the activity data store 220. The activity data store 220 can be cloud-based, in the associated endpoint (e.g., 102a), or distributed across multiple network locations.

In an exemplary multitenant SaaS security monitoring system environment where the activity data store 220 is implemented with (or as) one or more cloud data stores to record each tenant's user activities, for example: data is collected and stored all the tenants T on the network (e.g., 100 in FIG. 1). Typically, every tenant has users {u₁, u₂, u₃, . . . uₙ}, the users uₙ perform activities {a₁, a₂, a₃, . . . aₙ} represented by user activity data, and every activity aᵢ has an associated timestamp tsᵢ, associated metadata: {m₁, m₂, m₃, . . . mₙ}, and associated user information uiᵢ identifying the user that performed the corresponding user activity. Typically, data is added to the activity data store 220 in an ongoing manner such that the data stored in the activity data store 220 at any given point in time represents all of the data that has been collected by the system 200a from multiple endpoints (e.g., 102a-102l) on the network 100 over an extended prior period of time (e.g., immediately prior days, weeks, months, or even years).

Next, according to the exemplary implementation, the system 200a generates a sampled activity matrix 240. More specifically, in a typical implementation, the big data compute cluster-1 (226a) portion of the system 200a generates the sampled activity matrix. Typically, each sampled activity matrix that is generated will be based upon, and represent, at least some portion of the data that was stored in the activity data store 220 at the time that sampled activity matrix was generated. The sampled activity matrix typically forms a rectangular array (or “dataframe”) with numbers, for example, arranged in M rows and N columns, where M and N are positive whole numbers, and where each number in the array represents a property of the associated data from the activity data store 220.

In a typical implementation, each sampled activity matrix corresponds to (and, therefore, represents the user activities of) one, and only one, of the users: {u₁, u₂, u₃, . . . uₙ}. Thus, for a tenant that includes multiple users (e.g., {u₁, u₂, u₃, . . . uₙ}), the big data compute cluster-1 (226a) portion of the system 200a would generate multiple sampled activity matrices (e.g., one sampled activity matrix for each respective one of the multiple users (e.g., {u₁, u₂, u₃, . . . uₙ}).

In an exemplary implementation, each row in a sampled activity matrix represents one sample (e.g., one discrete period of time, such as one day) and each column corresponds to a particular activity-set. The phrase “activity-set” refers to an activity or a set of related activities that are performed together by a user at an endpoint within a certain amount of time (e.g., a few (2, 3, 4, 5, 6, 7, etc.) seconds or a few minutes) to accomplish a discrete task at the endpoint). Examples of related activities performed together by a user at an endpoint to accomplish a discrete task include activities sequences that include, for example, pressing Ctrl+C to copy a file from a source location and later pressing Ctrl+V to paste the file into a destination location on a personal computer. The number in each cell of a sampled activity matrix represents the number of times the corresponding activity-set was performed by the corresponding user during the corresponding period of time (e.g., on a given day).

More specifically, the steps involved in generating the sampled activity matrix 240 include querying the activity data store, preprocessing the user activity data, processing user activity sets, and sampling/aggregating. In a typical implementation, each of these steps is performed by the big data compute cluster-1 (226) and/or one of its sub-components (e.g., the user activity preprocessor 226a, the user activity-set processor 226b, or the sampler/aggregator 226c).

More specifically, in an exemplary implementation, the big data computer cluster-1 (226) queries the activity data store 220. The query may include one or more requests to retrieve one or more pieces of (or potentially all) the information collected and being stored in the activity data store 220 for one particular tenant. The activity data store 220, in response to the query, typically returns the requested data to the big data computer cluster-1 (226).

Next, the user activity preprocessor 226a in the big data computer cluster-1 (226) preprocesses the data that is returned by the activity data store. In various implementations, preprocessing may include, for example, filtering out certain data, or renaming some of the data or activities represented by the data, etc. In some implementations, the filtering out process may involve eliminating duplicates of particular pieces of data. In this regard, the user activity preprocessor 226a may compare the various pieces of data (user activity data and associated metadata, user information, and/or timestamps) to identify matches. If any matches are identified, the user activity preprocessor 226a may delete all but one matching data entries. In some implementations, the filtering out process may involve filtering out user activity data that is not deemed relevant to insider threat risk. In this regard, the user activity preprocessor 226a may review the various pieces of data (user activity data and associated metadata, user information, and/or timestamps) for one or more hallmarks indicating irrelevance to insider threat risk. These hallmarks may be stored in computer memory and referenced to perform the indicated review. Any pieces of data identified by the user activity preprocessor 226a as irrelevant (e.g., having one or more of the hallmarks indicating irrelevance) may be deleted, or flagged for exclusion from subsequent processing, by the user activity preprocessor 226a. In some implementations, the renaming may involve renaming to improve consistency of compliance with standard name formatting protocols, and/or improving the accuracy and/or descriptiveness of names to represent the associated data or activities. These preprocessing steps result in a preprocessed data set.

Next, according to an exemplary implementation, the sampler/aggregator 226c of the big data compute cluster-1 (226) samples the preprocessed data set, performs aggregation and creates one sampled activity matrix for each respective one of the users at the corresponding tenant. An example of a sampled activity matrix for a fictional user (e.g., “Bob”) at one of the tenants (e.g., Tenant A) on network 100 follows:

| | activi- | activi- | activi- | activity_class_4 + |
|---|---|---|---|---|
| | ty_class_1 | ty_class_2 | ty_class_3 | activity_class_5 |
| day₁ | 2 | 19 | 1 | 2 |
| day₂ | 2 | 21 | 2 | 18 |
| day₃ | 2 | 20 | 1 | 11 |
| . . . | . . . | . . . | . . . | . . . |
| dayₙ | 2 | 23 | 3 | 12 |

The foregoing exemplary sampled activity matrix forms a rectangular array with numbers arranged in N rows (day₁, day₂, day₃, . . . dayₙ) and four columns (activity_class_1, activity_class_2, activity_class_3, and activity_class_4+activity_class_5). Each row represents one particular day (and is labeled as such), and each column represents a particular class of activity or combination of activity classes performed within some predetermined amount of time (e.g., 2, 3, or 4 seconds) of one another (and is labeled as such). Thus, in the above sampled activity matrix, activity_class_4+activity_class_5 is an example of an activity-set as they occurred within t seconds of each other. The system 200 typically stores sampled activity matrix for every user in a data store that may be partitioned by tenant in the cloud data lake.

In a typical implementation, the big data compute cluster-1 (226) identifies occurrences to be represented in the sampled activity matrix by identifying individual user activities represented within the user activity data having similar characteristics as (and for inclusion in) each respective one of the activity classes. For activity_class_4+activity_class_5 column, the big data compute cluster-1 (226) may identify a pair of individual user activities that respectively match features associated with activity_class_4 and activity_class_5 features and determine whether that pair of user activities happened within a designated amount of time (e.g., within 2, 3, 4, or 5 seconds) of one another, based on respective timestamp data for the associated user activities.

In the exemplary sampled activity matrix (above), each number in the array represents the number of times that Bob performed a user activity that corresponds to a corresponding one of the activity classes on a corresponding one of the days at an endpoint (e.g., 102a) of network 100. Thus, as an example, and according to the illustrated sampled activity matrix, on day₁, Bob would have performed an activity falling within activity_class_1 twice, an activity falling within activity_class_2 nineteen times, an activity falling within activity_class_3 once, and an activity combination falling within activity_class_4+activity_class_5 twice. As another example, and according to the illustrated sample activity matrix, Bob would have performed an activity falling in activity_class_2 nineteen times on day₁, twenty one times on day₂, twenty times on day₃, and twenty three times on dayₙ.

Next, in an exemplary implementation, the sampled activity matrix for every user on the network is stored in the partitioned data store 228a on a cloud-based data lake 228. A partition is a division of a logical database (here, data store 228a) or its constituent elements into distinct independent parts. In various implementations, the partitioning can be done by either building separate smaller databases (each with its own tables, indices, transaction logs, and or sample activity matrices), or by splitting selected elements within the database. In an exemplary implementation, the sample activity matrices (240) are partitioned at least according to tenant with sample activity matrices for tenant A being partitioned from sample activity matrices for tenants B and C, with sample activity matrices for tenant B being partitioned from sample activity matrices for tenants A and B, and with sample activity matrices for tenant C being partitioned from sample activity matrices for tenants A and B. Thus, in a typical implementation, the sample activity matrices for every active user on the network is stored in the partitioned data store 228a and partitioned by tenant. In some implementations, additional (or different) partitioning schemes may be implemented as well. In a typical implementation, the data lake 228 is a cloud-based data lake.

Next, according to the illustrated flowchart, the system 200a generates a ranked list of activity sets 242 for each user. In a typical implementation, the ranked list of activity sets 242 ranks the user activities performed by the user (e.g., in order of relative variance). More specifically, to generate a ranked list of activity sets for a particular user (e.g., Bob), compute cluster-2 (230) queries the data lake 228 for the sampled user activity matrix for that particular users. The compute cluster-2 (230) then applies Principal Component Analysis (at PCA component 230a) to project the data from the sampled activity matrix for that particular user into N dimensions, where N is the number of columns (e.g., features or activity-sets) in the matrix. After projecting the data for each user into N dimensions and correlating the features with the dimensions, the features are sorted (e.g., by the ranked list builder 230b) in the order of their relative variance (lowest variance feature is at the top). This ranked list of activity-sets per user is stored in the User Profile Data Store 232. For example, using a reduced snapshot of the dataset, a ranked list of activity sets 242 for a user, “Bob,” may look like this:

| activity | rank |
|---|---|
| activity_class_{_{—}}₁ | 1 |
| activity_class_2 | 2 |
| activity_class_3 | 3 |
| activity_class_4 | 4 |
| activity_class_5 | 5 |
| activity_class_11 + activity_class_12 | 6 |

According to the foregoing exemplary ranked list of user activities, activity_class_1 has the lowest variance, activity_class_2 has the next lowest variance, activity_class_3 has the next lowest variance, activity_class_4 has the next lowest variance, activity_class_5 has the next lowest variance, and activity_class_11+activity_class_12 has the highest variance. In general, variance is a measure of dispersion, meaning it is a measure of how far a set of numbers is spread out from their average value. More specifically, in an exemplary implementation, variance refers to an expected value of the squared deviation of a random variable from its population mean or sample mean, for example.

Thus, in an exemplary implementation, the dataframe D created above is projected into N dimensions using Principal Component Analysis, where N is the number of activity-sets (also referred to as features interchangeably). The features of each user are then ranked relative to each other using the projected dimensions with the feature that correlates the most with the direction of the least variance ranked the highest in the list, and the feature that correlates the most with the direction of the highest variance ranked the lowest in the list. Each user in the tenant typically would have a list of features ranked in this way. This ranked list of features is stored in a behavior profile of the user (e.g., in the user profile data store 232). Thus, each user in the tenant would have a list of features ranked according to their relative variance depending on their past behavior. This list may be denoted (and labeled in the user profile data store 232, for example) as L.

Next, according to an exemplary implementation, the user activity weight calculator module 234 queries the user profile data store 232 for every user in a tenant and computes a weight Wᵢ for each activity-set for every user in the tenant using the ranked list of the activity-sets of the user as follows and stores the resulting score in the user profile store 232:

$$scores = \{ max\_score * x / N for x in range ( 1 , N + 1 ) \}$$

$$scores = sorted ( scores , reverse = True )$$

(Here N is the length of the list)

In a reduced dataset, for example, user Bob's activity-set weights may look like:

| activity | weight |
|---|---|
| activity_set_1 | 0.85 |
| activity_set_2 | 0.71 |
| activity_set_3 | 0.57 |
| . . . | . . . |
| activity_set_n | 0.18 |

In a typical implementation, the system 200a saves the foregoing information (e.g., the table, including the calculated weights in the table, as a user profile), in the user profile data store 232.

In a typical implementation, the system 200a (as represented by the refresh trigger 224) triggers the above pipeline (e.g., 222 in FIG. 8) at various intervals. The intervals may be regular, irregular, periodic, etc. This refresh cycling helps to keep the scores and user clusters fresh. The refresh trigger 224 may be on a timer, may be based on a count of new user activities recorded, etc.

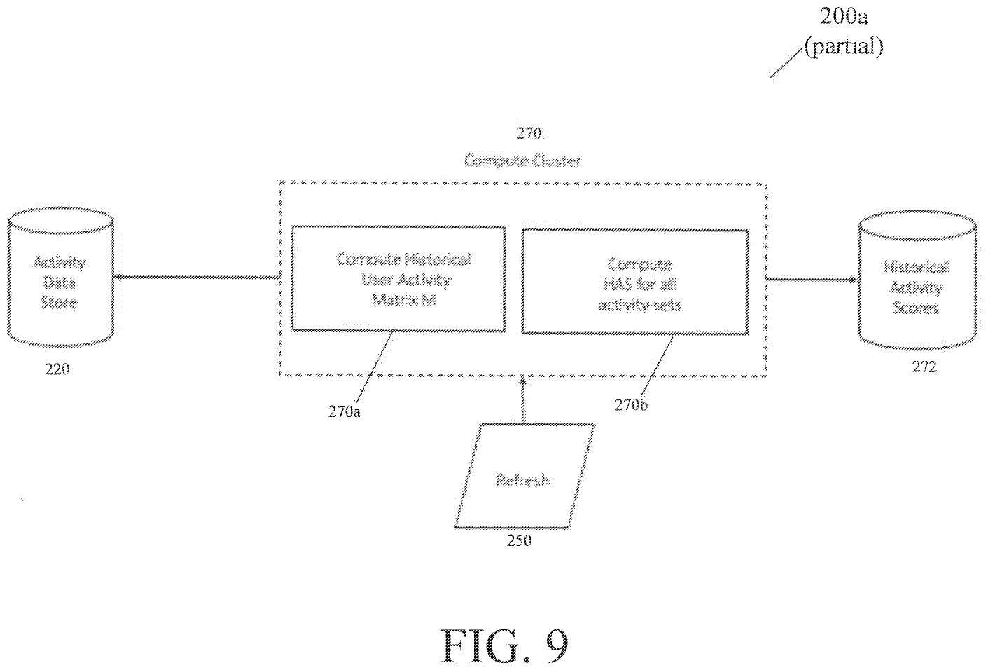

Next, and referring now to FIG. 9, the system 200, in an exemplary implementation, computes historical user activity scores across a particular tenant (e.g., tenant A). FIG. 9 is a schematic representation showing an exemplary high-level overview of the architecture (e.g., components and subcomponents) for this. The illustrated architecture includes the activity data store 220 (discussed above), a compute cluster component 270, a historical activity scores store 272, and a refresh trigger 250 for the illustrated pipeline. The activity data store 220 in the illustrated implementation is configured to interact with the compute cluster component 270 as indicated, the compute cluster component 270 is configured to interact with the historical activity scores store 272 as indicated, and the refresh trigger 250 is configured to interact with the compute cluster 270 as indicated.

The compute cluster 270 has components directed to computing a historical user activity matrix (270a) and for computing a historical user activity score (“HAS”) for all activity-sets (270b).

In a typical implementation, the system 200a (at 270a) computes the historical user activity matrix using the data retrieved from collected from the activity data store 220, which typically would have been collected from multiple sources/channels across the tenant network. Moreover, in a typical implementation, the historical user activity matrix is computed where each cell HCᵢⱼ in this matrix represents the sum of frequency of one particular activity-set (activity-setⱼ) for one particular user (userⱼ) calculated over some period of time (e.g., the previous X days). In a typical implementation, the system 200a using live-streaming user activity data in a given tenant, a Contextual User Activity Matrix is computed where each cell CCᵢⱼ in this matrix is the sum of the frequency of activity-setⱼ (e.g., activity-sets per hour) for userᵢ seen in the current time window (e.g., the last one hour). In an exemplary implementation, each cell in the matrix may be a number “n”—where n is the total number of a certain “activity-set” that a user performed over a certain time window.

The system 200a typically stores the historical user activity matrix and its underlying data in computer memory (e.g., in 220 or 270).

Additionally, the system 200a (at 270b) computes historical user activity scores across a tenant. More specifically, in an exemplary implementation, for each activity-set in the for each activity-set in the historical user activity matrix, the system 200a (at 270b) computes a historical user activity score (“HAS”) as follows. Assuming that the historical user activity matrix M has N rows and P columns where N represents the number of users in the tenant and P represents the number of activity-sets, then the system 200a computes a historical user activity score (“HAS”) for each activity-setⱼ as:

$${HAS}_{{j}_{j ∈ P}} = \frac{( N * [ 1 + log ( 1 + {σ}^{2} ( \vec{v} ) ) ) ]}{{\sum }_{i = 1}^{N} {HC}_{ij}}$$

where HCᵢⱼ corresponds to the frequency in the user activity matrix for activity-setⱼ and

$${user}_{i} , \vec{v} = \{ {HC}_{1 j} , {HC}_{2 j} , … , {HC}_{Nj} \} .$$

In a typical implementation, the system 200a stores the computed historical user activity scores in computer memory (e.g., in 272).

Thus, in a typical implementation, the compute cluster 270 queries the activity data store 220 and calculates or computes a historical user activity matrix (at 270a) and historical user activity (“HAS”) scores (at 270b) and stores them (e.g., in a data lake, at 272). In a reduced tenant dataset, for example, the stored HAS scores might look like this:

| activity | Historical Activity Score |
|---|---|
| activity_set₁ | 0.03 |
| activity_set₂ | 0.075 |
| activity_set₃ | 0.175 |
| activity_set₄ | 0.017 |
| activity_set₅ | 0.185 |

Typically, the historical user activity score computation pipeline (in compute cluster 270) is refreshed/triggered periodically (see refresh trigger 250) to keep the scores fresh. This period can be a static interval or set dynamically based on a user activity event in the cloud SaaS infrastructure, for example.

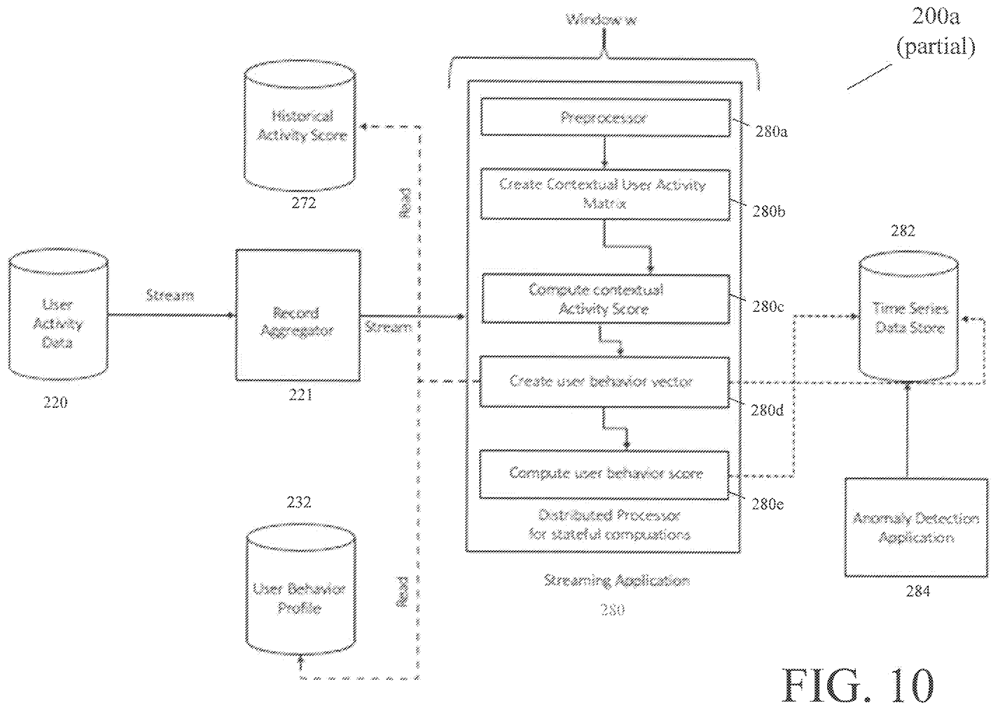

The system 200a, in an exemplary implementation, is also configured to performed inference processing. FIG. 10 is a schematic representation of an exemplary, high-level overview of an inference architecture that may be deployed as part of the system 200a.

The inference architecture of FIG. 10 includes the data store for user activity data 220, a record aggregator 221 data store for historical activity score data store 272, a user behavior profile data store (e.g., 232), a streaming application component 280, a time series data store 282, and an anomaly detection application component 284. The streaming application component 280, in the illustrated implementation, has a preprocessor 280a, and components for creating a contextual user activity matrix 280b, computing a contextual activity score 280c, creating a user behavior vector 280d, and computing a user behavior score 280e. In some implementations, such as the one represented in the figure, the streaming application is implemented using distributed processors (e.g., for stateful computations). Distributed processing refers to a setup in which multiple individual processors work on the same programs, functions, or systems to provide more capability for a computer or other device. In general, a streaming application can either be stateful or stateless. A stateless streaming application looks at each individual event in a stream of events and produces an output based only on the last event—for example, a streaming application could get continuous temperature readings from a weather sensor and raise an alert if a temperature reading exceeds 95 Fahrenheit. A stateful streaming application on the other hand produces results based on multiple events in the stream—like the streaming application disclosed herein where the system applies windows on the streaming data and aggregates the number of the activity-sets in that window.

According to the illustrated implementation, data flows through the system as follows. Data is provided into the streaming application 280 from the data store for user activity data 220, from the user behavior profile data store 232, and from the historical activity score data store 272. More specifically, the system 200a streams data from the data store for user activity data 220 through the record aggregator 221 and from the record aggregator 221 to the streaming application 280. Streaming refers to the fact that the data is delivered continuously or without delay whenever new user activity data becomes available, e.g., one packet at a time, usually for immediate processing at its destination. Data from the user behavior profile data store 232, and data from the historical activity score data store 272 is read into the streaming application 280 by the component in streaming application tasked with creating user behavior vectors 280d. The streaming application 280 outputs data (e.g., user behavior vectors from 280d and user behavior scores 280e) to the time series data store 282. The anomaly detection application 284 is configured to detect anomalies represented by the data in the time series data store 282.

In a typical implementation, the streaming application 280 is configured to operate with discrete windows of time (windows w) as follows. In every window w, the streaming application 280 (at 280b) generates a contextual user activity matrix M (as discussed above) with N rows and P columns where N represents the number of active users during the window and where P represents the number of different current activity-sets in the tenant during the time window w.

Next, in an exemplary implementation, the system 200a (at 280c) uses the contextual user activity matrix M just created (at 280b) to compute contextual user activity score(s). In this regard, the system 200a may compute such contextual user activity score(s) (e.g., across a tenant) as follows. More specifically, in this regard, for each activity-set in the contextual user activity matrix, a contextual user activity score may be computed as follows. Given a contextual user activity matrix M that has N rows and P columns where N represents the number of active users in the tenant during the current time window and P represents the number of current activity-sets in the tenant during the time window, the contextual user activity score (“CAS”) of each activity-setⱼ may be defined (and computed at 280c) as:

$${CAS}_{{j}_{j ∈ P}} = \frac{( N * [ 1 + log ( 1 + {σ}^{2} ( \vec{v} ) ) ) ]}{{\sum }_{i = 1}^{N} {CC}_{ij}}$$

where CCᵢⱼ corresponds to the frequency in the user activity matrix for activity-setⱼ and

$${user}_{i} , \vec{v} = \{ {CC}_{1 j} , {CC}_{2 j} , … , {CC}_{Nj} \} .$$

Further, in each time window w, the system 200a (at 280d) creates a user behavior vector Vᵢ of length Kⱼ for each userᵢ in that time window. Kⱼ may be different for each userᵢ. Also, each Kⱼ may be less than or equal to P. In a typical implementation, each element in a user behavior vector Vᵢ is the product of the aggregated frequency Fⱼ of the user's activity-setⱼ in the current time window, the Historical User Activity Score of the activity-setⱼ, the Contextual User Activity Score of the activity-setⱼ and the Weight Wⱼ of the activity-setⱼ retrieved from the user's profile. Element here refers to an individual item in a user behavior vector. For example, if a user behavior vector looks like [1.5, 2.0. 4.7], the elements of the user behavior vector are the items 1.5, 2.0 and 4.7.

The system 200a (at 280e), in an exemplary implementation, then computes a user behavior score from the user behavior vector Vᵢ as follows:

$${Score}_{{i}_{i ∈ N}} = ( {\sum }_{j = 1}^{{K}_{j}} {F}_{j} * {HAS}_{j} * {CAS}_{j} * {W}_{j} ) * \frac{1}{{K}_{j}}$$

A user's behavior vector is a representation of multiple activity-sets performed by the user in a time window. The system typically uses the HASs of all the activity-sets seen during the time window while computing the behavior vector. In small example, let us assume that Bob performs activity-set-a 2 times, activity-set-b 3 times and activity-set-c 1 time in a given time window. Further, let us assume that activity-set-a's HAS is 10, CAS is 5, weight from the user profile is 1, activity-set-b's HAS is 2, CAS is 3, weight from the user profile is 0.5 and activity-set-c's HAS is 5, CAS is 4, and weight from the user profile is 2. Bob's user behavior vector in the given time window would then look like:

[2*10*5*1,3*2*3*0.5,1*5*4*2]=[100,9,40]

In a typical implementation, the system 200a stores the scores and behavior vectors of each user in the time series data store 282 along with the start and end timestamps of the staggered window (e.g., w). In case of an unseen activity-set, default max HAS and CAS scores close to 1.0 are assigned. While creating a user behavior vector the system may come across an activity-set that it had never seen earlier while computing the activity scores (corner case)—and so it may not have an activity score for this activity-set. The system, in some such instances, may classify such activity-sets as unseen (as never encountered earlier) and assign them a default score (close to or at 1.0, e.g., greater than 0.8, greater than 0.9, greater than 0.95, greater than 0.99, etc.).

After n windows (e.g., regular time window intervals thereafter), the system 200a triggers the anomaly detection application 284. The anomaly detection application 284 queries the time series data store 282 and gets the current window's behavior scores for every user, the past m windows' behavior scores for every user, and then computes the deviation of a user's current behavior score (e.g., using z-scores, as discussed herein) from that user's baseline score, which is based on that user's own prior behavior (e.g., mean and standard deviation of the user's behavior scores over the previous windows). If the deviation is greater than a threshold (e.g., a threshold value stored in computer memory), the user's behavior is flagged (via one or more flagging methods disclosed herein) as being anomalous in the current time window, and the system 200a notifies a responsible party accordingly.

Thus, in a simple exemplary case, deviation can be measured using a z-score. In a small example, let us assume that User Bob's Behavior Scores in the previous windows are 10, 20 and 30. In this case, Bob's baseline would be {Mean: 20, Standard Deviation: 10}. Further, let us assume that in the current window during which the system runs the inference, Bob's behavior score is 40. This means that Bob's current behavior has a z-score of 2, and the system would determine that. Moreover, if 2 is greater than the predefined threshold value (e.g., stored in computer memory), then Bob's current behavior score would be flagged (by the system) as an anomaly and a notification (e.g., in the form of an electronic communication of some sort) may be generated to alert a responsible party within Bob's tenant.

Alternatively, the application can query the time-series data-store and get the user behavior vectors of the past m windows and train a one class Support Vector Machine model for every user, get and feed the user behavior vector (e.g., from 280d) of every user in the current time window to their respective trained one class SVM model, and then detect anomalous user behavior with respect to each user's own past behavior (established baseline). One-Class SVM is an unsupervised learning technique/system that learns a boundary around the normal behavior vectors identifying them as one single class of normal vectors while assigning any vector that falls outside of this hypersphere to be anomalous vectors. A one class SVM model may be trained for every user using their behavior vectors from previous windows and using this the current behavior vector is classified to be either anomalous or not anomalous.

Thus, in an exemplary implementation, during inference, staggered windows of size z may be applied on the streaming user activity data. In each window, user activity data may be aggregated to compute a contextual user activity matrix (at 280b) and contextual user activity score (at 280c), as disclosed herein. Further, in each time window, a user behavior vector Vᵢ is computed for each user Uᵢ where each element in the vector Vᵢ may be the product of the following four factors: 1) the aggregated frequency of the user's activity-setⱼ in the time window, 2) the HAS score of activity-setⱼ, 3) the CAS score of activity-setⱼ, and 4) the weight Wⱼ of the activity-setⱼ retrieved from the user's profile.

The score derived from this activity vector Vᵢ is then assigned to each user, and the scores of each user (over multiple time windows) are stored in an index (e.g., 282) along with the entire activity vector Vᵢ. These scores indexed over multiple time windows form a baseline behavior pattern for each user. After n windows, new user scores may be compared against their baseline behavior pattern, and any significant deviation (e.g., greater than 30%, greater than 40%, greater than 50%, greater than 60%, etc.) from the baseline may be flagged as an anomaly. Alternatively, the behavior vectors of users may be fed into a one class Support Vector Machine (SVM) algorithm to detect deviation of each user from their established baseline.

### Exemplary Deployment(s) and Hardware Details

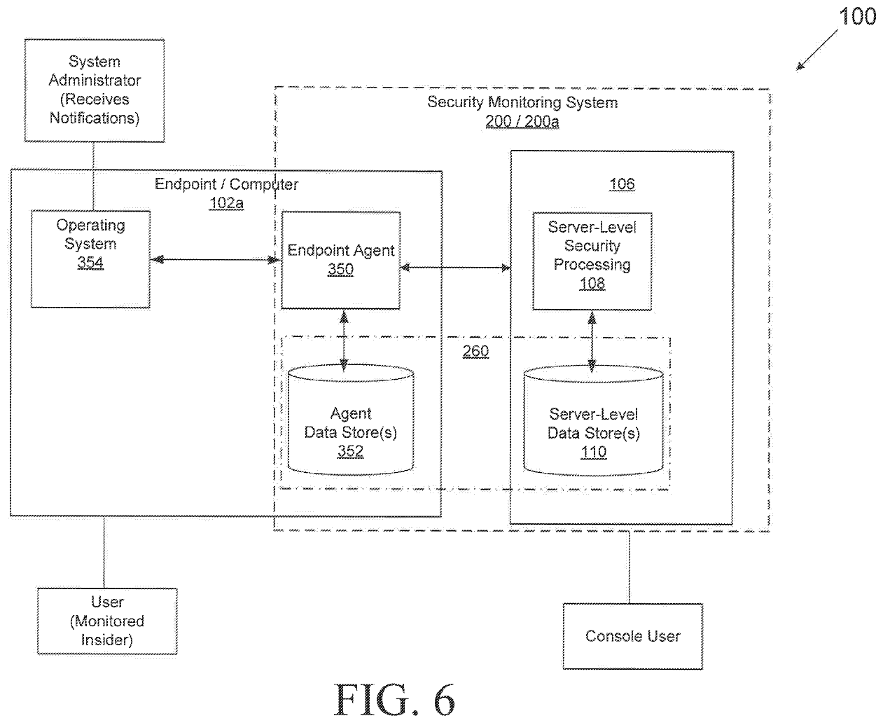

FIG. 6 is a schematic representation of an implementation showing a portion of the security monitoring system 200/200a of FIGS. 2-5 and/or FIGS. 8-10 deployed across a portion of the computer network 100 of FIG. 1.

The portion of computer network 100 represented in FIG. 6 includes one of the endpoints 102a on the network 100 and the remote security monitoring platform 106 at a server that is connected to the endpoint 102a via a communication network 112 (see, FIG. 1), such as the Internet. In a typical implementations, the server, which may be a cloud-based server, hosts the remote security monitoring platform 106 that communicates with the endpoint agent 320 via the communication network.

The security monitoring system 200/200a represented in FIG. 6, for example, is implemented in a distributed fashion across the endpoint 102a and the remote security monitoring platform 106. More specifically, a first portion of the security monitoring system 200/200a is deployed on the endpoint 102a and a second portion of the security monitoring system 200/200a is deployed on the security monitoring platform 106 at the remote server. The components in the first portion of the security monitoring system 200, which resides at the endpoint 102a, include an endpoint agent 350 and (optionally) one or more agent-level data store(s) 352. In general, the endpoint agent 350 is configured to perform any and all processing related to the security monitoring functionalities disclosed herein that may occur, in various implementations, at the endpoint 102a. Some examples of those functionalities include collecting user activity data and one or more functionalities associated with one or more of the various system components represented, for example, in FIG. 2-5 or 8-10. In general, the one or more agent-level data stores, if present, provide storage for data related to those security monitoring functionalities.

The components of the second portion of the security monitoring system 200/200a, which resides at the remote server, include hardware (e.g., processor(s)) to provide server-level security processing 108 and one or more server-level data store(s) 110). In general, the server-level security processing 108 is configured to perform any and all processing related to the security monitoring functionalities disclosed herein that may occur, in various implementations, at the server/remote security monitoring platform 106. Those functionalities may include one or more functionalities associated with one or more of the various system components represented, for example, in FIGS. 2-5 and/or FIGS. 8-10. In various implementations, examples may include: 1. identifying and/or alerting on internal threats like deviations in a user's behavior pattern as compared to the group to which they belong, etc., 2. identifying and/or monitoring groups of users with (e.g., similar) activity patterns, 3. creating and/or monitoring user behavior profiles (e.g., for every user in a tenant)—this user behavior profile generally learns the activity patterns of each unique user in the tenant, 4. understanding and/or monitoring popular user activities in a tenant and also activities that are less frequently acted on by users, and/or 5. providing dashboard and/or reporting tools to monitor user activities.

Moreover, in general, the one or more agent-level data stores, if present, provide storage for data related to those security monitoring functionalities.

In a typical implementation, the endpoint agent 350 is configured to communicate with and interact with the operating system 354 and/or other internal components (e.g., applications, session agents, etc., not shown in FIG. 6) in the endpoint 102a. For example, the endpoint agent 350 may register for notifications from the operating system 354 when a specific user related activity is detected by the operating system 354. Upon receipt of a notification from the operating system 354 by the endpoint agent 350, the endpoint agent 350 may communicate notification data received from the operating system 354 to the remote server hosting the remote security monitoring platform 106. For example, in some implementations, the endpoint agent 350 may forward all the notification data it receives to the remote server 106. In some implementations, the endpoint agent 350 may selectively forward only some of the notification data to the remote server 106. For example, the endpoint agent 350 may be configured (e.g., by the server 106) with a selection criteria to determine what notification data to forward to the server 106. Moreover, the agent 320 may process notification data it receives from the operating system 120 (e.g., in view of the selection criteria) and then forward one or more notifications to the monitor application server depending on the outcome of its processing. The various data stores (e.g., 220, 228, 232) and the cluster index component 238 may be distributed between the agent data store 352, which is resident on the endpoint 102a, and the server-level data store(s) 110, which is resident on the external remote server.

The endpoint agent 350 may be tailored to communicate with a specific operating system 120 resident on the endpoint 102a. For example, the agent 320 may be specifically configured to communication with the Windows OS, MacOS, or Unix/Linux, among others.

While FIG. 6 shows a single remote server, the remote server may be distributed across two or more physical server devices. Likewise, the server-level data store(s) 110 may be distributed across two or more physical server devices.

In general, in some implementations, the endpoint agent 350 may be configured to act as an intermediary between the operating system 354 and the security monitoring platform 106 at the remote server. In some implementations, the endpoint agent 350 could convey collected data to the remote server, and the remote server may operate upon the collected data to determine if targeted activities have been performed by an insider (e.g., the “user” in FIG. 6) at the endpoint 102a. Alternatively, the agent endpoint agent 350 may operate upon the collected data and then convey information to monitor application server 310 depending on the outcome of the agent's operations.

In an exemplary implementation, the user is a human who interacts with the endpoint 102a (e.g., as an employee or insider at tenant A), the system administrator is a human who may, for example, control and configure the operating system 350 of the endpoint 102a, and a console user may be a human who controls and interacts with the security monitoring system 200. The system administrator also may be the party who receives notifications from the system 200 of identified insider user behavior threats (or deviations in user behavior suggesting an insider behavior threat). Of course, there may be a plurality of users, system administrators, and/or console users. Different users, for example, may share computers or may have their own respective computers 110. In some circumstances the same individual may serve as system administrator and console user.

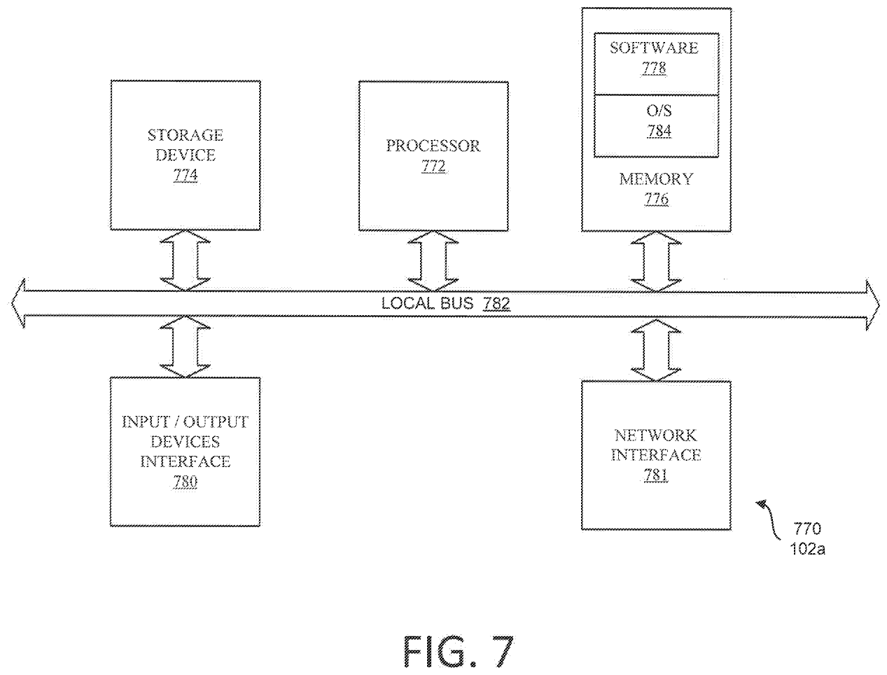

FIG. 7 is a schematic representation of an exemplary implementation of a computer device 750 (e.g., endpoint 102a) configured to perform some of the computer implemented ITM functionalities disclosed herein, and (in conjunction with other computer devices in the network 100) facilitate other computer-implemented ITM functionalities disclosed herein.

The illustrated computer 750 has a processor 772, computer-based memory 776, computer-based storage 774, a network interface 781, an input/output device interface 780, and an internal bus 782 that serves as an interconnect between the various subcomponents of the computer 750. The bus acts as a communication medium over which the various subcomponents of the computer 750 can communicate and interact with one another.

The processor 772 is configured to perform the various computer-based functionalities disclosed herein as well as other supporting functionalities not explicitly disclosed herein. In some implementations, some of the computer-based functionalities that the processor 772 performs may include one or more functionalities disclosed herein as being attributable to a corresponding one of the computer devices on network 100, for example, or disclosed in connection with FIGS. 2-5. In some implementations, the processor 772 performs these and other functionalities by executing computer-readable instructions stored on a computer-readable medium (e.g., memory 776 and/or storage 774). In various implementations, some of the processor functionalities may be performed with reference to data stored in one or more of these computer-readable media and/or received from some external source (e.g., from an I/O device through the I/O device interface 780 and/or from an external network via the network interface 781).

The processor 772 in the illustrated implementation is represented as a single hardware component at a single node. In various implementations, however, the processor 772 may be distributed across multiple hardware components at different physical and network locations.

The computer 770 has both volatile and non-volatile memory/storage capabilities.

In the illustrated implementation, memory 776 provides volatile storage capabilities. In a typical implementation, memory 776 serves as a computer-readable medium storing computer-readable instructions that, when executed by the processor 772, cause the processor 772 to perform one or more of the computer-based functionalities disclosed herein. More specifically, in some implementations, memory 776 stores computer software that enables the computer to automatically implement computer functionalities in accordance with the systems and computer-based functionalities disclosed herein.

As shown in the figure, memory stores software 778 and an operating system 784.

In a typical implementation, one or more user interface devices (e.g., keyboard, mouse, display screen, microphone, speaker, touchpad, etc.) is connected to the I/O devices interface 780 to facilitate user interactions with the system.

In various implementations, every computer and/or server and/or other computing device on the network (e.g., 100 in FIG. 1) has the same configuration as the schematically represented computer 770 in FIG. 7. In some implementations, a computer and/or server and/or other computing device may include fewer (e.g., some subset of the) subcomponents than shown in FIG. 7.

A number of embodiments of the invention have been described. Nevertheless, it will be understood that various modifications may be made without departing from the spirit and scope of the invention.

In some instances, the systems and techniques disclosed herein may be implemented as a stand-alone solution However, in some instances, the systems and techniques disclosed herein may be incorporated into an existing insider threat management platform, such as the ObserveIT Insider Threat Management (ITM) solution, available from Proofpoint. Inc., the applicant of the current application.

It should be understood that the example embodiments described herein may be implemented in many different ways. In some instances, the various methods and machines described herein may each be implemented by a physical, virtual, or hybrid general purpose computer, such as a computer system, or a computer network environment, such as those described herein. The computer/system may be transformed into the machines that execute the methods described herein, for example, by loading software instructions into either memory or non-volatile storage for execution by the CPU. One of ordinary skill in the art should understand that the computer/system and its various components may be configured to carry out any embodiments or combination of embodiments of the present invention described herein. Further, the system may implement the various embodiments described herein utilizing any combination of hardware, software, and firmware modules operatively coupled, internally, or externally, to or incorporated into the computer/system.

Various aspects of the subject matter disclosed herein can be implemented in digital electronic circuitry, or in computer-based software, firmware, or hardware, including the structures disclosed in this specification and/or their structural equivalents, and/or in combinations thereof. In some embodiments, the subject matter disclosed herein can be implemented in one or more computer programs, that is, one or more modules of computer program instructions, encoded on computer storage medium for execution by, or to control the operation of, one or more data processing apparatuses (e.g., processors). Alternatively, or additionally, the program instructions can be encoded on an artificially generated propagated signal, for example, a machine-generated electrical, optical, or electromagnetic signal that is generated to encode information for transmission to suitable receiver apparatus for execution by a data processing apparatus. A computer storage medium can be, or can be included within, a computer-readable storage device, a computer-readable storage substrate, a random or serial access memory array or device, or a combination thereof. While a computer storage medium should not be considered to be solely a propagated signal, a computer storage medium may be a source or destination of computer program instructions encoded in an artificially generated propagated signal. The computer storage medium can also be, or be included in, one or more separate physical components or media, for example, multiple CDs, computer disks, and/or other storage devices.

Certain operations described in this specification can be implemented as operations performed by a data processing apparatus (e.g., a processor/specially programmed processor/computer) on data stored on one or more computer-readable storage devices or received from other sources, such as the computer system and/or network environment described herein. The term “processor” (or the like) encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations may be described herein as occurring in a particular order or manner, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Various component (e.g., as shown in FIG. 2-5, etc.) disclosed herein may be implemented, for example, by one of more computer hardware components (e.g., one or more computer processors) executing computer readable instructions stored on computer-readable media (e.g., hardware memory in the form of RAM, ROM, etc.) to perform the associated computer-implemented functionalities described herein.

If a user threat is detected and signaled to an appropriate authority for a tenant company, for example, a system administrator and/or company management, then the system administrator and/or company management may take any number of subsequent real-world steps to address, remedy, and/or prevent future instances of the behavior that led to the threat being detected. In some instances, this may include investigating the threat and/or speaking to (and possibly reprimanding) the user whose behavior caused the threat to be detected. The reprimanding could include and/or be accompanied by reducing or changing the user's role within the organization, reducing or changing the user's authority to access certain areas of the organization's network (e.g., by changing user access control settings for that user in the organization's access control software), changing the user's remuneration for his or her job at the organization, and/or terminating the employees employment at the organization (e.g., with a termination letter or other comparable communication—email, etc.). Termination may, in some instances, involve (or require) escorting the employee off the physical premises. The employee, once terminated, may be expelled from, and prevented from subsequently accessing any of the organization's property, including any real estate (e.g., office space, etc.) and/or computer networks (locally or remotely, e.g., over the Internet). There are many ways in which the company may implement reactive policies for responding to an identified insider threat.

Other implementations are within the scope of the claims.

What is claimed is:

1. A computer-facilitated method to detect internal user behavior threats in a multitenant software as a service (SaaS) security system by comparing behavior of a user in a particular one of the tenants to behavior of other users in the tenant:
recording user activity data representing activities by a plurality of users within the tenant at endpoints on a computer network associated with the tenant;
generating a sampled activity matrix for each respective one of the plurality of users based on the recorded user activity data;
grouping users from the particular tenant into clusters based on similarity between ranked lists of activity-sets for each user, wherein the ranked list of activity-sets for each user is derived from the recorded user activity data for that user;
assigning a user activity weight to each respective one of the activity-sets in the sampled activity matrices;
creating a ranked list of the user activity-sets for all the users within the tenant in each respective one of a plurality of time windows across all the discrete periods of time, based on a variance computation;
computing a user behavior vector for each respective one of the users in the tenant;
comparing the user behavior vector for a particular one of the users in the tenant to other users in the tenant to determine whether the user behavior vector indicates that the user behavior deviates beyond a threshold amount from the other users in the tenant; and
creating an internal user behavior threat notification in response to a determination that the user behavior deviates beyond the threshold amount from the other users in the tenant.

2. The computer-facilitated method of claim 1, wherein recording the user activity data comprises:
collecting the user activity data from a plurality of sources within a portion of the computer network that corresponds to the tenant over time; and
storing the collected user activity data in a computer-based activity data store together with associated timestamps and associated metadata.

3. The computer-facilitated method of claim 1, wherein the sampled activity matrix for each respective one of the plurality of users comprises a plurality of cells, wherein each cell identifies how many times that user performed a corresponding one of activity-sets during a particular one of the discrete periods of time.

4. The computer-facilitated method of claim 1, wherein each respective one of the activity-sets is an activity or a set of related activities that were performed by a corresponding one of the users at one of the endpoints on the computer network within a predetermined amount of time.

5. The computer-facilitated method of claim 1, wherein grouping the users from the particular tenant into clusters comprises:
applying spectral clustering to a similarity matrix that provides a measure of similarity between each respective one of the users in the tenant to each respective other user in the tenant to create the clusters.

6. The computer-facilitated method of claim 5, further comprising:
generating the similarity matrix, wherein generating the similarity matrix comprises:
generating a first list of the activity-sets for a particular one of the users ranked in ascending order according to relative variance;
generating a second of activity-sets for the particular one of the users ranked in descending order according to relative variance.

7. The computer-facilitated method of claim 6, wherein generating the similarity matrix further comprises:
calculating a first similarity score between each pair of users in the tenant using a rank biased overlap algorithm with a tunable parameter that determines a contribution of top-ranked activity-sets in the list of the activity-sets to a first similarity score, wherein the first similarity score is calculated from the first list of the activity-sets; and
calculating a second similarity score between each pair of users in the tenant using the rank biased overlap algorithm, wherein the second similarity score is calculated from the second list of the activity-sets.

8. The computer-facilitated method of claim 7, wherein generating the similarity matrix further comprises:
calculating a mean similarity score for each respective pair of users in the tenant based on the first and second similarity scores; and
populating each cell of a matrix with one of the mean similarity scores to produce the similarity matrix, wherein each cell in the similarity matrix corresponds to a particular one of the pairs of users.

9. The computer-facilitated method of claim 1, further comprising:
creating each of the ranked lists of activity-sets for each user by:
applying principal component analysis (PCA) to project the data from the sampled activity matrix for each respective one of the users into N dimensions, where N is the number of activity sets represented in the sampled activity matrix; and
ranking the activity-sets from the sampled activity matrix based on relative variance following the PCA of the sampled activity matrix to produce a corresponding one of the ranked lists.

10. The computer-facilitated method of claim 1, wherein assigning a user activity weight to each respective one of the activity-sets in the sampled activity matrices comprises:
calculating each of the user activity weights as:
weights={max _score*x/N for x in range(1,N+1)},
weights=sorted(scores,reverse=True),
wherein N represents a number of entries.

11. The computer-facilitated method of claim 1, wherein creating each of the ranked lists of the user activity-sets comprises:
grouping the user activity data into multiple different time buckets based on timestamping of the user activity data;
further grouping the user activity data into multiple different cluster groups based on cluster identifying data associated with the user activity data;
after multiple cycles of the grouping and further grouping, aggregating the grouped and further grouped user activity data over the multiple cycles to create a grouped user activity matrix, wherein each cell in the matrix holds a value of the sum of frequency of a particular user activity-set represented in the user activity data for a particular one of the users in a particular one of the time buckets over the multiple cycles;
ranking the user activities across multiple groupings in the tenant using a contextual relative activity variance for each of the activity-sets in all the groupings.

12. The computer-facilitated method of claim 1, wherein computing the user behavior vector for each respective one of the users in the tenant comprises:
grouping user activity-sets based on assigned cluster identifiers in each of a plurality of time buckets; and
creating the user behavior vector in every group, wherein each behavior vector has a length equal to a number of unique activity-sets for that user, and wherein each element in the user behavior vector is a product of aggregated frequency of the user's activity set in a particular time bucket, a CRAV score of the activity set, and a weight Wⱼ of the activity-set, wherein a score for the user behavior vector is calculated as follows:
$${Score}_{{i}_{i ∈ N}} = ( {\sum }_{j = 1}^{{K}_{j}} {F}_{j} * {CRAV}_{j} * {W}_{j} ) * \frac{1}{{K}_{j}}$$
where CRAVⱼ is a tenant activity score read from a matched group and Wⱼ is a weight of the activity read from a user's profile.

13. The computer-facilitated method of claim 1, further comprising:
taking one or more real-world steps, as a human being, to address, investigate, and/or remedy the effects of a user's behavior at one of the endpoints on the network in response to receiving the internal user behavior threat notification at one of the endpoints on the network.

14. A computer system configured to detect internal user behavior threats in a multitenant software as a service (SaaS) security system by comparing behavior of a user in a particular one of the tenants to behavior of other users in the tenant, the computer system comprising:
a computer processor; and
computer-based memory operatively coupled to the computer processor, wherein the computer-based memory stores computer-readable instructions that, when executed by the computer processor, cause the computer-based system to:
record user activity data representing activities by a plurality of users within the tenant at endpoints on a computer network associated with the tenant;
generate a sampled activity matrix for each respective one of the plurality of users based on the recorded user activity data;
group users from the particular tenant into clusters based on similarity between ranked lists of activity-sets for each user, wherein the ranked list of activity-sets for each user is derived from the recorded user activity data for that user;
assign a user activity weight to each respective one of the activity-sets in the sampled activity matrices;
create a ranked list of the user activity-sets for all the users within the tenant in each respective one of a plurality of time windows across all the discrete periods of time, based on a variance computation;
compute a user behavior vector for each respective one of the users in the tenant; and
compare the user behavior vector for a particular one of the users in the tenant to other users in the tenant to determine whether the user behavior vector indicates that the user behavior deviates beyond a threshold amount from the other users in the tenant; and
create an internal user behavior threat notification in response to a determination that the user behavior deviates beyond the threshold amount from the other users in the tenant.

15. A non-transitory computer readable medium having stored thereon computer-readable instructions that, when executed by a computer-based processor, cause the computer-based processor to detect internal user behavior threats in a multitenant software as a service (SaaS) security system by comparing behavior of a user in a particular one of the tenants to behavior of other users in the tenant, by:
recording user activity data representing activities by a plurality of users within the tenant at endpoints on a computer network associated with the tenant;
generating a sampled activity matrix for each respective one of the plurality of users based on the recorded user activity data;
grouping users from the particular tenant into clusters based on similarity between ranked lists of activity-sets for each user, wherein the ranked list of activity-sets for each user is derived from the recorded user activity data for that user;
assigning a user activity weight to each respective one of the activity-sets in the sampled activity matrices;
creating a ranked list of the user activity-sets for all the users within the tenant in each respective one of a plurality of time windows across all the discrete periods of time, based on a variance computation;
computing a user behavior vector for each respective one of the users in the tenant; and
comparing the user behavior vector for a particular one of the users in the tenant to other users in the tenant to determine whether the user behavior vector indicates that the user behavior deviates beyond a threshold amount from the other users in the tenant; and
creating an internal user behavior threat notification in response to a determination that the user behavior deviates beyond the threshold amount from the other users in the tenant.
